(19) United States
(12) Patent Application Publication
(10) Pub. No.: US 2010/0155649 A1
(43) Pub. Date: Jun. 24, 2010

(54) MOLECULE-BASED MAGNETIC POLYMERS AND METHODS

(75) Inventors: Chang Dae Han, Akron, OH (US); Wenyi Huang, Akron, OH (US)

Correspondence Address: HAHN LOESER & PARKS, LLP, One GOJO Plaza, Suite 300, AKRON, OH, 44311-1076, US

(73) Assignee: THE UNIVERSITY OF AKRON, Akron, OH (US)

(21) Appl. No.: 12/717,607

(22) Filed: Mar. 4, 2010

Related U.S. Application Data
(63) Continuation-in-part of application No. PCT/US08/75311, filed on Sep. 5, 2008.
(60) Provisional application No. 60/970,752, filed on Sep. 7, 2007.
(60) Provisional application No. 60/970,723, filed on Sep. 7, 2007.

(51) Int. Cl. H01F 1/26; C08G 77/58

(52) U.S. Cl. 252/62.54; 528/9

(57) ABSTRACT

Molecule-based magnetic polymers with high Curie temperature and methods of preparing are provided. In particular, magnetic polymers having repeating units of an electron-donor metallocene-containing monomer covalently bonded to an electron-acceptor monomer having a plurality of unpaired electrons are disclosed. Intrinsically homogeneous magnetic fluids (liquid magnets) and methods of preparing are also provided.

### CROSS REFERENCE TO RELATED APPLICATIONS

This U.S. patent application is a continuation-in-part (CIP) application of PCT International Application No. PCT/U.S.08/75311 filed on Sep. 5, 2008, which claims the benefit of U.S. Provisional Patent Application Ser. Nos. 60/970,723 filed on Sep. 7, 2007 and 60/970,752 filed on Sep. 7, 2007, all of which are hereby incorporated herein by reference.

### TECHNICAL FIELD

The invention relates to magnetic polymers and methods of making such polymers, and magnetic fluids. More particularly, the invention relates to magnetic polymers and methods of making such polymers with electron-donor metallocene compounds and electron-acceptor organic-based compounds with unpaired electrons. Intrinsically homogeneous magnetic fluids (liquid magnets) and methods of preparing are also provided. The magnetic fluids may include a magnetic polymer in a carrier solvent.

### BACKGROUND OF THE INVENTION

Magnets serve an indispensable function in our technology-based society and are ubiquitous in all varieties of mechanical and electronic devices in science and industry. Traditional magnets are atom-based, and are comprised of the transition, lanthanide, or actinide metals, with the magnetism arising from the magnetic dipole moment that is a product of the presence of unpaired electrons in the d- or f-orbitals.

Previous research attempts to design and synthesize molecular organic magnets and high-spin molecules with intrinsic magnetic properties were unsuccessful and very few have been found to be of industrial use, as such molecules had a fairly low ferromagnetic transition temperature, commonly referred to as Curie temperature (T_{c}). There remain fundamental obstacles that seem to block the ability to resolve scientific difficulties to developing organic magnets with high T_{c} (much higher than room temperature). There are only a few examples of organic magnets that have T_{c} above room temperature, but such materials are insoluble and infusible as well as unstable under ambient environment, and thus the problem of fabrication of magnetic films and liquid magnets still remains unresolved. Since the magnetic anisotropy in organometallic magnets is considerably lower than that in the case of metal-containing compounds arising from the weak spin-orbital coupling between s and p electrons, high-T_{c} molecular magnets have not yet been realized.

Development of molecule-based magnetic polymers would be worthwhile because they may exhibit numerous desirable properties, including solubility, processability, and synthetic tenability. Such features are a direct result of the molecular nature of molecule-based magnetic polymers and are not shared by traditional atom-based magnets. Molecule-based magnetic polymers provide prospects for new nanoscale molecular materials as functional magnetic memory devices leading to dramatically enhanced data processing speeds and storage capacity in computers or many other applications. Such polymeric magnets would be lighter, more flexible, and less intensive to manufacture than conventional metal and ceramic magnets. Just for example, applications could include magnetic shielding, magneto-optical switching, and candidates for high-density optical data storage systems.

The theory of magnetism is primarily based on two quantum mechanical concepts: electron spin and Pauli Exclusion principles. From the Curie law, the magnetic susceptibility (χ) is expressed by χ=N²gβ²S(S+1)/3k_{B}T where β is the effective magnetic moment, g is g-factor, N is Avogadro's number, S is the spin angular momentum, k_{B} is the Boltzmann constant, and T is the absolute temperature. Thus, χ is proportional to S² (thus high spin is required for high magnetic properties), but inversely proportional to T. Also, there is a critical temperature, T_{c}, below which the ferromagnetic materials exhibit spontaneous magnetization. To date, the most challenging issue for the synthesis of molecule-based magnetic polymers is to increase the T_{c} to well above room temperature, which is desirable for industrial applications.

The conventional molecular/organic magnets used at present are all atom-based. They exist in the form of crystals or complexes through noncovalent bonds (e.g., hydrogen bonding, ionic interactions, or metal coordinations), and thus spin coupling largely depends on the lattice distance of the crystal, because the exchange interaction is proportional to 1/r¹⁰. Some efforts have been directed to the formation of a charge-transfer (CT) complex to design and synthesize molecular/organic magnets. It has been noted that there are large positive and negative atomic densities in certain structures (e.g. aromatic radicals), and that atoms of positive spin density are exchange coupled most strongly to atoms of negative spin density in neighboring molecules. The delocalization of spin density in macromolecular chains makes it possible for magnetic interactions to take place across extended bridges between magnetic centers separated from each other, propagating through conjugated bond linkages, which act as molecular wires. Spin polarization, i.e., the simultaneous existence of positive and negative spin densities at different locations within a given radical is needed for intermolecular exchange interactions to bring about ferromagnetic interactions. Employing iron or transition metal with larger radial orbitals as magnetic centers will improve the overlap between the orbitals of electron acceptor (A⁻) and electron donor (D⁺), namely spin coupling. Currently, there have been no successful attempts reported on the synthesis of molecule-based donor-acceptor magnetic polymers.

Magnetic polymers based on p-orbital spins typically exhibit weak ferromagnetic properties and thus T_{c} is still below 10 K even when S reaches 5000. Therefore, it is necessary to incorporate much stronger magnetic centers into the macromolecular chains, such as iron or other transition metals having the unpaired electrons located in d- or f-orbitals.

Existing superparamagnetic nanocomposites typically contain magnetic particles (e.g., Fe, Co, Ni etc.) in the form of powder or flakes in a non-magnetic polymer matrix. Due to the tendency of aggregation of magnetic particles when added to a non-magnetic polymer matrix, the magnetic particles were typically treated with a surfactant or another polymer in order to help suppress aggregation. Owing to a much higher density of magnetic particles compared with that of non-metallic polymer matrix, the magnetic particles had a tendency to settle out at rest or during storage. Consequently, non-uniform dispersion of magnetic particles in the polymer matrix and poor heat dissipation during use represent additional problems.

The volume fraction of the magnetic particles in superparamagnetic nanocomposites is much smaller than that of the matrix polymer, and therefore the resulting magnetic level is not high. Thus, applications of superparamagnetic nanocomposites are limited.

Further limitations of superparamagnetic nanocomposites include the lack of solubility in common solvents which prevents them from being used in the preparation of intrinsically homogeneous magnetic fluids (liquid magnets). Thus, magnetic particles (e.g., iron oxide or ferrite) are suspended in a carrier liquid to prepare so-called ferrofluids, and they are used in industry. Thus, ferrofluids are characterized as suspensions of magnetic particles in a carrier fluid, which suffer from the same problem as superparamagnetic nanocomposites in that the magnetic particles tend to aggregate and also sediment at rest.

Ferrofluids currently in use are typically suspensions containing magnetic particles (iron oxide or ferrite for example) with typical volume fractions of 0.3-0.4 in a carrier fluid (typically silicone oil). There is another type of suspensions of magnetic particles, referred to as magnetorheological fluid (MR) fluid. The difference between ferrofluids ad MR fluids lies in the size of magnetic particles. Whereas the sizes of magnetic particles used to prepare ferrofluids are about 5-20 nanometers (nm), the sizes of the magnetic particles used to prepared MR fluids are about 5-20 micrometers (μm), i.e., about 1000 times larger the particle size normally used for the preparation of ferrofluids. The conventional, commercially available MR fluids typically contain an organic additive in order to stabilize the dispersion of aggregates of magnetic particles. Due to the large difference in density between the magnetic particles (having a density of 5-6 g/cm³) and a carrier fluid (having a density less than 1 g/cm³), the conventional MR fluids have serious technical problems. In particular, the magnetic particles in the conventional MR fluids settle out over a relatively short period of time (i.e., in a few minutes to a few hours). Another technical difficulty is related to the lack of redispersibility of the magnetic particles in the conventional MR fluids. After the magnetic particles settle, they form highly dense aggregates, the extent of which depends on the chemical structure of a carrier fluid. To help disperse the aggregates of magnetic particles in a heterogeneous MR fluid, considerable efforts have been spent on treating the particles with a surfactant or a polymeric gel during the preparation of such MR fluids, but these attempts have not resolved the deficiencies.

Notwithstanding the state of the art as described herein, there is a need for further improvements in molecule-based (i.e., homogeneous) magnetic fluids and polymers. These types of fluids and polymers (without the presence of magnetic nanoparticles) would have numerous applications and would enable the preparation of intrinsically homogeneous liquid magnets without the need for magnetic particles, which can then replace ferrofluids or MR fluids that have inherent difficulties of sedimentation and aggregation of magnetic particles, and other deficiencies.

### SUMMARY OF THE INVENTION

In one example of the invention, molecule-based magnetic fluids and polymers and methods of preparing these fluids and compounds are disclosed. In a further embodiment of the invention, a series of monomers having multiple unpaired electrons (“spins”) are prepared and thus play the role of electron acceptor resulting in the formation of donor-acceptor polymers with an electron donor with at least one transition metal, for example iron, cobalt, or nickel that is located within a ferrocene-, cobaltocene-, or nickelocene-containing and biferrocene-, bicobaltocene-, or binickelocene-containing monomer. The two monomers can then be polymerized to obtain covalently linked molecule-based magnetic polymers. The synthesized polymers are soluble in organic solvents, since they may have long flexible, bulky side chains.

In another example of the invention, a magnetic polymer having repeating units of a metallocene-containing electron-donor monomer covalently bonded to a monomer having a plurality of unpaired electrons is disclosed. Such polymers can be synthesized by covalent bonding, for instance, between a metallocene-containing electron-donor monomer and an electron-acceptor organic-based monomer with unpaired electrons.

In a further example of the invention, a method of preparing a magnetic polymer is disclosed. The method includes the steps of preparing a metallocene-containing electron-donor monomer, preparing a monomer having a plurality of unpaired electrons, and polymerizing the metallocene-containing electron-donor monomer and monomer having a plurality of unpaired electrons to form a magnetic polymer.

In still yet another example of the invention, an intrinsically homogeneous magnetic fluid (liquid magnet) includes a carrier solvent without containing any magnetic particles, while the molecule-based magnetic polymer comprises repeating units of an organometallic monomer covalently bonded to a monomer having a plurality of unpaired electrons.

### BRIEF DESCRIPTION OF THE DRAWINGS

FIG. 1 describes examples of synthesis routes for the molecule-based magnetic polymers according to the invention.

FIG. 2 describes the FTIR spectrum of 2,6-diamineanthraquinone trifluorodiacetate.

FIG. 3 describes the ¹H NMR spectrum of 2,6-diamineanthraquinone trifluorodiacetate in DMSO.

FIG. 4 describes the FTIR spectrum of 2,6-diamine-11,11,12,12-tetracyanoanthraquino-dimethane trifluorodiacetate.

FIG. 5 describes the ¹H NMR spectrum of 2,6-diamine-11,11,12,12-tetracyanoanthraquino dimethane trifluorodiacetate in DMSO.

FIG. 6 describes the FTIR spectrum of 2,6-diamine-11,11,12,12-tetracyanoanthraquino-dimethane.

FIG. 7 describes the ¹H NMR spectrum of 2,6-diamine-11,11,12,12-tetracyanoanthraquino-dimethane in DMSO.

FIG. 8 describes the ¹³C NMR spectrum of 2,6-diamine-11,11,12,12-tetracyanoanthraquino-dimethane in DMSO.

FIG. 9 describes the ESR spectrum of 2,6-diamine-11,11,12,12-tetracyanoanthraquinodimethane at room temperature.

FIG. 10 describes the FTIR spectrum of 2,6-diazido-11,11,12,12-tetracyanoanthraquino-dimethane.

FIG. 11 describes the ¹H NMR spectrum of 2,6-diazido-11,11,12,12-tetracyanoanthraquino-dimethane in CDCl₃.

FIG. 12 describes the FTIR spectrum of 1,1′-bis(trimethylsilyl)ferrocene.

FIG. 13 describes the ¹H NMR spectrum of 1,1′-bis(trimethylsilyl)ferrocene in CDCl₃.

FIG. 14 describes the FTIR spectrum of 1,1′-bis(diphenylphosphino)-3,3′-bis(trimethylsilyl)ferrocene.

FIG. 15 describes the ¹H NMR spectrum of 1,1′-bis(diphenylphosphino)-3,3′-bis(trimethylsilyl)Ferrocene in CDCl₃.

FIG. 16 describes the ³¹P NMR spectrum of 1,1′-bis(diphenylphosphino)-3,3′-bis(trimethylsilyl)ferrocene in CDCl₃ using phosphorus acid as an external reference.

FIG. 17 describes the FTIR spectra of a molecule-based polymer P1.

FIG. 18 describes the ¹H NMR spectra of a molecule-based polymer P1 in CDCl₃.

FIG. 19 describes the GPC scan of a molecule-based polymer P1 using polystyrene as a standard, with a number-average molecular weight (Mₙ) of 38,720, weight-average molecular weight (M_{w}) of 53,670, and polydispersity (M_{w}/Mₙ) of 1.39.

FIG. 20 describes the differential scanning calorimetric (DSC) thermogram of a molecule-based polymer P1 at a heating rate of 10° C./min.

FIG. 21 describes the thermogravimetric analysis (TGA) trace of a molecule-based polymer P1 at a heating rate of 10° C./min.

FIG. 22 describes the magnetic behavior of a molecule-based polymer P1: plot of magnetization versus magnetic field 200 K.

FIG. 23 describes the ESR spectra of a molecule-based polymer P1 at 300 K.

FIG. 24 describes the XRD pattern of (a) a molecule-based polymer P1 and (b) iron oxide.

FIG. 25 describes photographs of homogeneous solutions prepared from a molecule-based magnetic polymer P1 in tetrahydrofuran at 10 wt % and 30 wt %.

### DETAILED DESCRIPTION OF THE INVENTION

The synthesis procedures for examples of a series of high-T_{c} molecule-based magnetic polymers and the presentation of representative properties of the example synthesized magnetic polymers are presented herein. These molecule-based magnetic polymers are soluble in common solvents, offering good processability. The term “molecule-based”, as used herein, refers to the state of covalent bonding between elements and/or atoms during the formation of large molecules, i.e. polymers. The molecule-based magnetic polymers, as described herein, are intrinsically homogeneous in nature. The magnetic polymers of the invention have a high Curie temperature or a Tc above room temperature, and more particularly well above room temperature. This allows the fabrication and use for a wide variety of applications. The Curie temperature of the magnetic polymer according to the invention will depend on the chemical structure of the particular molecule-based magnetic polymer, and can vary accordingly. For many applications, the Curie temperature of the magnetic polymer is desired to be well above room temperature, such as up to about 200 degrees Celsius for example, before the magnetic polymer begins to undergo thermal degradation. It is noted that the Curie temperature denotes the highest temperature at which magnetic behavior can be observed, i.e., at temperatures above the Curie temperature of a magnetic polymer, the polymer ceases to exhibit magnetic characteristics. Based on the application and environment in which the magnetic polymer is to be used, the Curie temperature may be above the temperatures to be expected in such application or environment, to prevent degradation of the magnetic characteristics thereof.

The design and synthesis of molecule-based magnetic polymers may be based on the following theoretical considerations. Namely, (a) the macromolecular chains must have magnetic centers with unpaired electrons, (b) the unpaired electrons should have their spins aligned parallel along a given direction, (c) conjugated structure plays an important role in intramolecular spin coupling along the macromolecular chain, (d) the distance between electron donating center and electron accepting center should be as small as possible, ensuring the largest spin coupling, and (e) spin coupling must extend to three dimensions, due to the cooperative effect of magnetism, which can be realized from the spin delocalization and spin polarization along the macromolecular chains, and intermolecular exchange interactions.

These molecule-based magnetic polymers may provide a new generation of ferromagnetic materials having numerous practical applications. These applications include diagnostics, bioassays and life sciences research, as they provide a means of separation of substances from complex mixtures. In brief, a ligand (e.g., antibody or antigen), is either non-covalently or covalently attached to the magnetic polymers through chemical means. Other applications include exclusion seals for computer disc drives, applications such as seals for bearings, for pressure and vacuum sealing devices, for heat transfer and damping fluids in audio speaker devices. Further applications include magnetic toner and inkjet formulations. Further, the magnetic polymers can be used to prepare intrinsically homogeneous magnetic fluids (liquid magnets) for numerous practical applications.

Intrinsically homogeneous magnetic may be used in many different applications. For instance, in the automotive industry, magnetic fluids may be used for electrically controllable shock absorbers, clutches, inertial damper, actuators, and engine mounts. The reason for the use of magnetic fluids in such applications lies in that an applied magnetic field induces an orientation of spins in electrons along the direction of magnetic field, giving rise to a very high resistance to flow, often referred to as “yield stress.” Field-induced yield stress is a very unique characteristic of magnetic fluids. The rheological properties of magnetic fluids such as viscosity, yield stress, and stiffness can be altered by an external magnetic field. The unique features of these changes are fast (on the order of milliseconds for example), significant, and nearly completely reversible. Specifically, in the “off” state (when no magnetic field is applied), the magnetic centers are randomly distributed, and thus the magnetic fluid behaves like a Newtonian fluid, whereas, in the “on” state (when a magnetic field is applied), the magnetic centers would orient in the direction of applied magnetic field, which causes the magnetic fluid to exhibit semisolid behavior with increased yield stress, characteristic of Bingham fluids. The viscosity of magnetic fluids is dependent on the magnitude and direction of the applied magnetic field as well as the shear rate. For example, field-induced yield stress will help a driver to stop a car quickly.

The invention therefore is directed to molecule-based homogeneous molecule-based magnetic polymers, with such polymers usable as polymers and in intrinsically homogeneous magnetic fluids. The term “homogeneous”, as used herein, refers to a substantially “single phase” state in which no free magnetic particles or extraneous foreign particles exist in the synthesized magnetic polymer product in the bulk state, for solids, or in the liquid state, for fluids.

Previous attempts to synthesize molecule-based magnetic polymers were unsuccessful. In the present invention, theoretical considerations were used to develop the synthesis of the chemical structures from monomers that enhance spin-spin interactions between the constituent components, which then leads to molecule-based magnetic polymers after polymerization. It was considered previously that the synthesis of molecule-based magnetic polymers with high T_{c} would not be possible without using a monomer having a metallic element (e.g., iron. cobalt, or nickel).

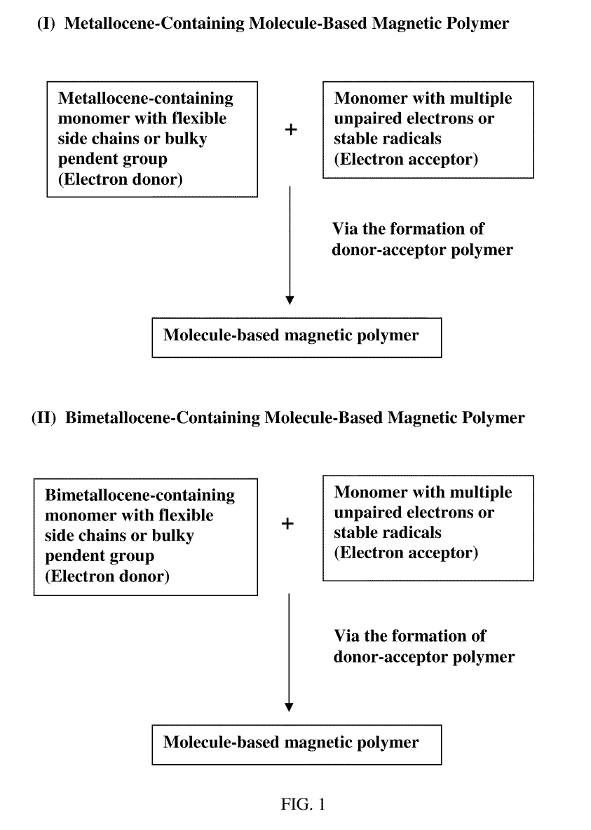

Thus, as examples of the invention, a series of monomers have been synthesized as an electron acceptor resulting in the formation of donor-acceptor polymer with an electron donor with at least one transition metal-containing organometallic compound, for example a metallocene, that includes iron, cobalt, or nickel in ferrocene-, cobaltocene-, or nickelocene-containing or biferrocene-, bicobaltocene-, binickelocene-containing monomer. The two monomers were then polymerized to obtain covalently linked molecule-based magnetic polymers. A variety of polymerization approaches may be suitable, and an example is a Staudinger reaction between one monomer with azide groups and the other monomer with phosphine groups. Staudinger reaction has many advantages in that it does not require the use of any catalyst because most metal (like palladium) containing catalysts would form complexes with electron-accepting monomers and in turn lose their catalyzing properties, as well as it occurs in neutral conditions at room temperature. The synthesized polymers may be soluble in carrier fluids or solvents, because of the flexible side chains or bulky pendent groups. Another promising mechanism of polymerization may resort to Knoevenagel reaction. Judicious modification of both electron-accepting and electron-donating monomers would enable Knoevenagel reaction to occur in a weak-base solution under mild conditions to afford magnetic polymers. On the other hand, since tetracyanoethylene (TCNE) has extremely high reactivity with ethynyl group in the presence of strong electron donating groups like amino group, it is wise to synthesize metallocene-containing conjugated polymers having ethynyl group and amino group in such a way that TCNE can react with ethynyl group in this polymer after polymerization and accordingly afford the electron donating and accepting charge transfer complex along the macromolecular chain. The rationale behind this idea lies in that a plethora of catalyst systems that are commonly employed in the synthesis of conjugated polymers may be used to achieve high molecular weight metallocene-containing conjugated polymers, circumventing the situation of possible coordination of tetracyano group with metal ion-containing catalysts. In an embodiment of the invention, synthesis routes for molecule-based magnetic polymers are shown in FIG. 1.

In one embodiment, a suitable candidate for the carrier fluid or solvent for the preparation of homogeneous magnetic fluid, but are not limited to, an organic fluid, or an oil-based fluid. Suitable carrier fluids which may be used include tetrahydrofuran, N,N-dimethylformamide, chloroform, dichloromethane, natural fatty oils, mineral oils, polyphenylethers, dibasic acid esters, neopentylpolyol esters, phosphate esters, synthetic cycloparaffins and synthetic paraffins, unsaturated hydrocarbon oils, monobasic acid esters, glycol esters and ethers, silicate esters, silicone oils, silicone copolymers, synthetic hydrocarbons, perfluorinated polyethers and esters and halogenated hydrocarbons, and mixtures or blends thereof. Hydrocarbons, such as mineral oils, paraffins, cycloparaffins (also known as naphthenic oils) and synthetic hydrocarbons are one of the classes of carrier fluids contemplated. In certain examples, aqueous based fluids are contemplated as carrier fluids or solvents for the magnetic polymers. In one example, the carrier fluid comprises substantially all one fluid. In another example, the carrier fluid is a mixture of one or more carrier fluids. In a further example, the carrier fluid comprises an aliphatic hydrocarbon.

The magnetic properties of molecule-based polymers would be highly dependent upon the chemical nature of electron donating and electron accepting units as well as the bridge linking these units. With this understanding, the following magnetic polymers based on 11,11,12,12-tetracyano-9,10-anthraquinodimethane (TCNAQ), 7,7,8,8-tetracyano-p-quinodi-amine (TCNQ) and tetracyanoethylene (TCNE) have been synthesized.

Synthesis of TCNAQ-Based Magnetic Polymers

TCNAQ has attracted special attention due to the facile synthesis by Lehnert's reagent and stability of molecular structure as well as the feasibility of modifying TCNAQ with functional groups for polymerization. For this reason, the electron-accepting monomers based on TCNAQ has been synthesized and functionalized with azide groups, which would react with the phosphine groups in metallocene or bimetallocene monomers to afford the corresponding magnetic polymers.

1. Synthesis of TCNAQ-Based Electron Accepting Monomers

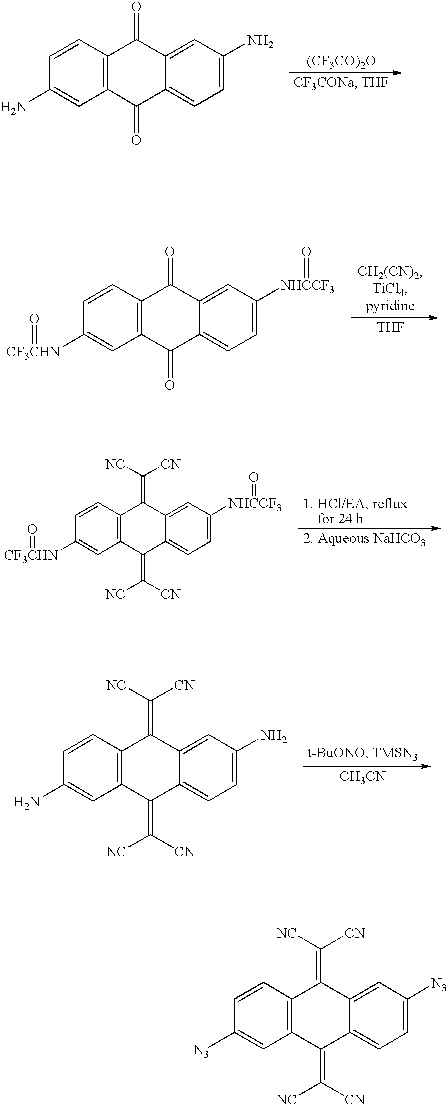

### Example 1

### Preparation of 2,6-diazido-11,11,12,12-tetracyanoanthraquinodimethane (TCNAQ-N₃)

### (i) Preparation of 2,6-diamineanthraquinone trifluorodiacetate

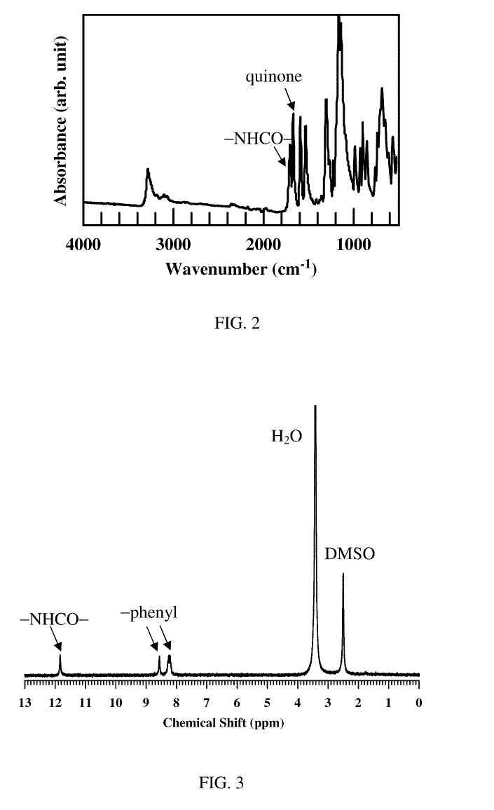

The purpose of this reaction is to protect amino group. 2,6-diamineanthraquinone (2.4 g, 10 mmol) and sodium trifluoroacetate (4.2 g, 30 mmol) were dissolved in 50 mL anhydrous tetrahydrofuran (THF), and then 10 mL trifluoroacetic anhydride was added in portions. After that, the reaction mixture was heated to reflux in a stream of argon gas overnight. The solution was then allowed to cool down to room temperature and poured into 200 mL cold water. The precipitate was filtered and washed with water, followed by recrystallizing from ethanol three times to give 4.0 g light yellow powder. Yield: 92%. ¹H NMR (8, DMSO): 8.25 (m, 4H, —CH—), 8.56 (s, 2H, —CH—), 11.88 (s, 2H, —NH—). FTIR spectrum (cm⁻¹): 3280 (—NHCO—), 3070, 1710 (—CO—), 1670 (quinone), 1590 (phenyl). The Fourier transform infrared (FTIR) spectrum of 2,6-diamineanthraquinone trifluorodiacetate is shown in FIG. 2, and the (proton nuclear magnetic resonance (¹H NMR) spectrum of 2,6-diamineanthraquinone trifluorodiacetate in DMSO is shown in FIG. 3.

### (ii) Preparation of 2,6-diamine-11,11,12,12-tetracyanoanthraquinodimethane trifluorodiacetate

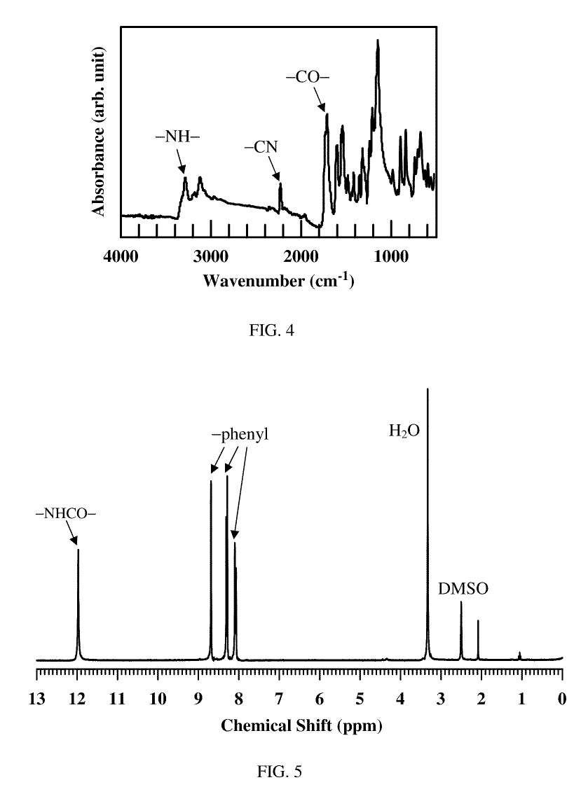

To a solution of 2,6-diamineanthraquinone trifluorodiacetate (2.1 g, 5 mmol) and malononitrile (1.6 g, 25 mmol) in 30 mL anhydrous tetrahydrofuran was added dropwise 3.3 mL TiCl₄ (30 mmol), followed by 4.8 mL anhydrous pyridine (60 mmol) over 60 min at 0° C. After the mixture was refluxed overnight, the solvent was removed under reduced pressure. The residue was treated with icy water and extracted with ethyl acetate. The combined organic layers were dried over anhydrous MgSO₄. After filtration and removal of solvent, the crude product was purified over silica gel column chromatography using hexane/ethyl acetate (1:1, v/v) as an eluent, and then recrystallized from hexane/ethyl acetate (1:3, v/v) to afford 1.4 g yellowish powder. Yield: 55%. ¹H NMR (8, DMSO): 8.10 (d, 2H, —CH—), 8.32 (d, 2H, —CH—), 8.32 (d, 2H, —CH—), 11.96 (s, 2H, —NH—). FTIR spectrum (cm⁻¹): 3290 (—NHCO—), 3120, 1710 (—CO—), 1600 (phenyl). The FTIR spectrum of 2,6-diamine-11,11,12,12-tetracyanoanthraquino-dimethane trifluorodiacetate is shown in FIG. 4, and the ¹H NMR spectrum of 2,6-diamine-11,11,12,12-tetracyanoanthraquinodimethane trifluorodiacetate in DMSO is shown in FIG. 5.

### (iii) Preparation of 2,6-diamine-11,11,12,12-tetracyanoanthraquinodimethane

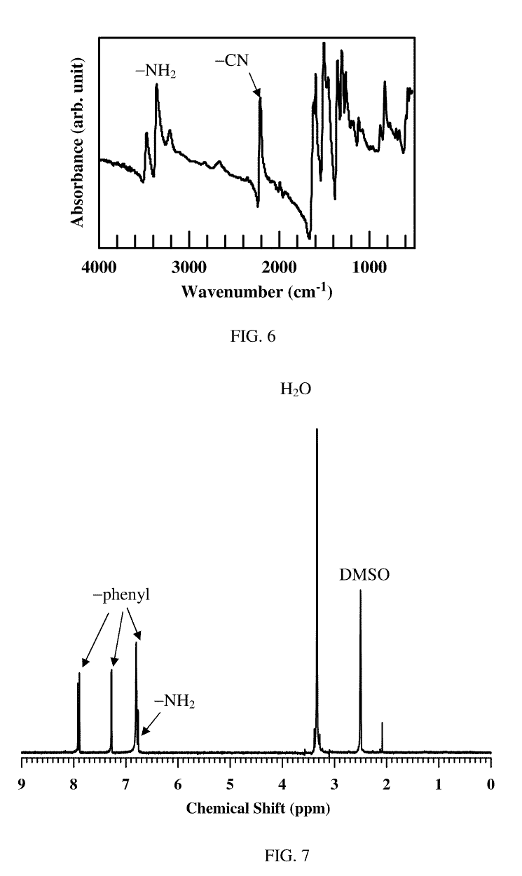

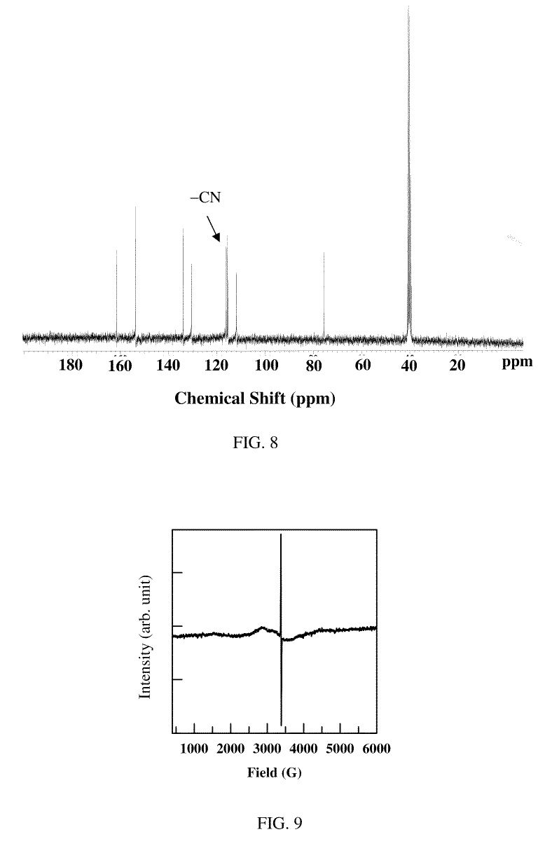

2,6-Diamine-11,11,12,12-tetracyanoanthraquinodimethane trifluorodiacetate (2.6 g, 5 mmol) was dissolved in 50 mL ethyl acetate, to which 50 mL of mixed solution of concentrated HCl/ethyl acetate (1/3, v/v) was added dropwise. The reaction mixture was heated to reflux for 24 h, during which white precipitate was formed. After cooling to 0° C., the solution was slowly added to 200 mL saturated NaHCO₃ aqueous solution. The organic layer was separated and washed three times with distilled water, and then dried over Na₂SO₄. After the solvent was removed under vacuum, the crude product was purified over silica gel column chromatography using hexane/acetone (4:3, v/v) as an eluent, and then recrystallized from hexane/ethyl acetate (1:1, v/v) to give 1.1 g dark red powder. Yield: 65%. ¹H NMR (8, DMSO): 6.79 (d, 4H, —NH₂), 6.80 (d, 2H, —CH—), 7.29 (d, 2H, —CH—), 7.93 (d, 2H, —CH—). ¹³C NMR (8, DMSO): 75.9, 112.1, 116.1, 116.6, 116.8, 131.2, 134.0, 153.8, 161.9. FTIR spectrum (cm⁻¹): 3470 (—NH₂), 3360 (—NH₂), 3220 (—NH₂), 2210 (—CN), 1620 (—NH₂), 1600 (phenyl). The FTIR spectrum of 2,6-diamine-11,11,12,12-tetracyanoanthraquinodimethane is shown in FIG. 6, the ¹H NMR spectrum of 2,6-diamine-11,11,12,12-tetracyanoanthraquinodimethane in DMSO is shown in FIG. 7, the (caron-13 nuclear magnetic resonance) (¹³C NMR) spectrum of 2,6-diamine-11,11,12,12-tetracyanoanthraquinodimethane in DMSO is shown in FIG. 8, and the electron spin resonance (ESR) spectrum of 2,6-diamine-11,11,12,12-tetracyanoanthraquino-dimethane at room temperature is shown in FIG. 9.

### (iv) Preparation of 2,6-diazido-11,11,12,12-tetracyanoanthraquinodimethane

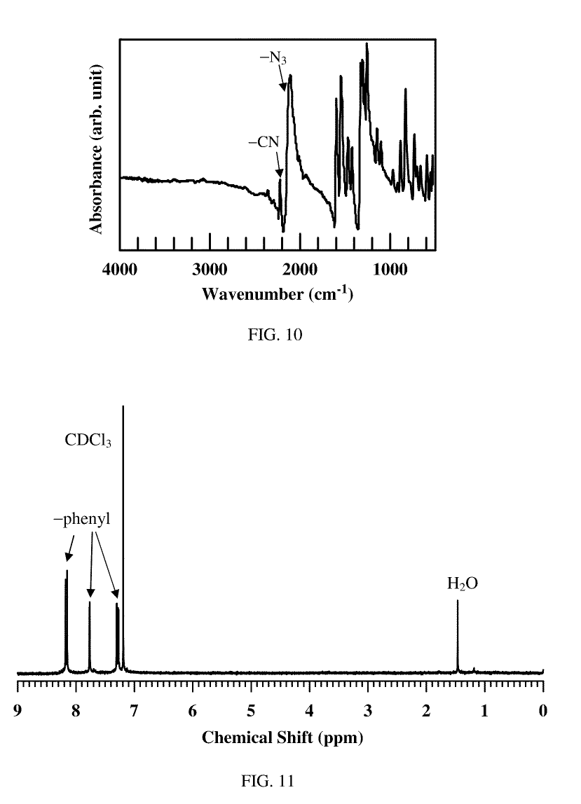

In a 250 mL round-bottom flask, 2,6-diamine-11,11,12,12-tetracyanoanthraquino-dimethane (3.3 g, 10 mmol) was dissolved in 50 mL anhydrous acetonitrile and cooled to 0° C. in an ice bath. To this stirred mixture was added 4.0 mL tert-butyl nitrite (30 mmol) followed by 4.2 mL azidotrimethylsilane (30 mmol) dropwise. The resulting solution was stirred at room temperature for 20 h. The reaction mixture was concentrated under vacuum, and the crude product was purified by silica gel chromatography using CH₂Cl₂ as an eluent. After removing CH₂Cl₂, 20 mL tetrahydrofuran was added to dissolve the product and then precipitated in hexanes for three times, giving 2.1 g brown powder. Yield: 55%. ¹H NMR (δ, CDCl₃): 7.29 (d, 2H, —CH—), 7.78 (s, 2H, —CH—), 8.15 (d, 2H, —CH—). FTIR spectrum (cm⁻¹): 2220 (—CN), 2110 (—N₃), 1600 (phenyl). The FTIR spectrum of 2,6-diazido-11,11,12,12-tetracyanoanthraquino-dimethane is shown in FIG. 10 and the ¹H NMR spectrum of 2,6-diazido-11,11,12,12-tetracyanoanthraquinodimethane in CDCl₃ is shown in FIG. 11.

### 2. Synthesis of Electron Donating Metallocene or Bimetallocene Monomers

One of the existing problems that must be overcome to synthesize a truly molecule-based magnetic polymer is the solubility of the polymer in commercially available solvents. In one embodiment of the invention, a metallocene or bimetallocene monomer with flexible side chains was prepared. Previous research showed that a ferromagnetic polymer synthesized without flexible side chains was not soluble in organic solvents. Therefore, when a magnetic polymer is not soluble in a solvent, its practical use is very limited in that the fabrication of many useful industrial products would not be possible.

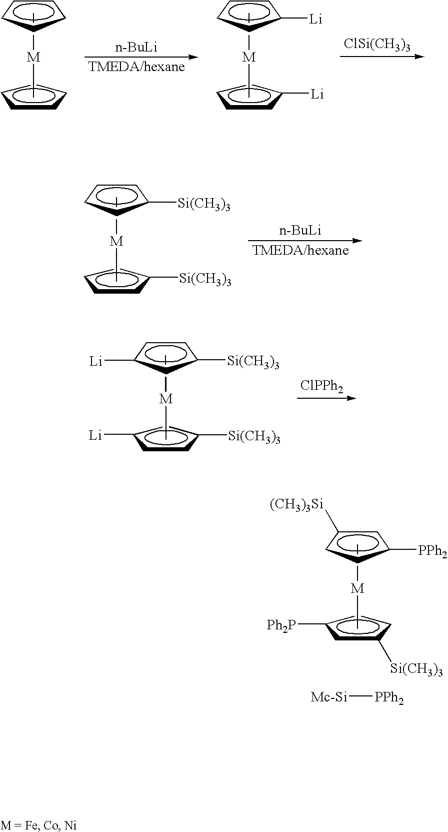

The rationale for the synthesis of bimetallocenes was based upon the fact that doubling the number of metallocene groups would enhance significantly the ferromagnetic behavior of the polymers to be synthesized, because of their easy formation of mixed-valence Fe(II)-Fe(III) species and charge transfer complex.

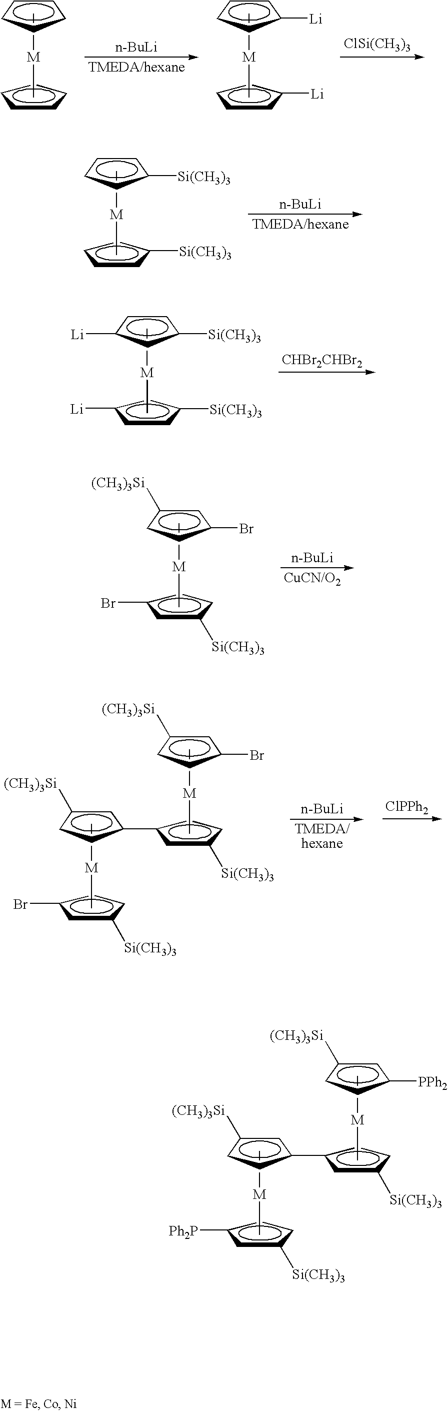

In order to reduce the shielding effects of bulky groups like trimethylsilyl and diphenylphosphine groups on the metallocene center, another metallocene monomer with phosphine having bis(diethylamino) groups was synthesized according to the following reaction scheme:

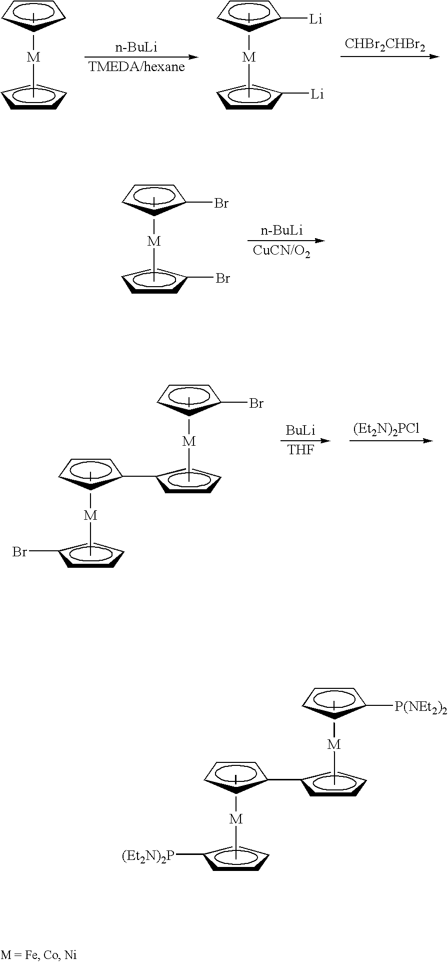

### Example 2

### Preparation of 1,1′-bis(diphenylphosphino)-3,3′-bis(trimethylsilyl)ferrocene

### (i) Preparation of 1,1′-bis(trimethylsilyl)ferrocene

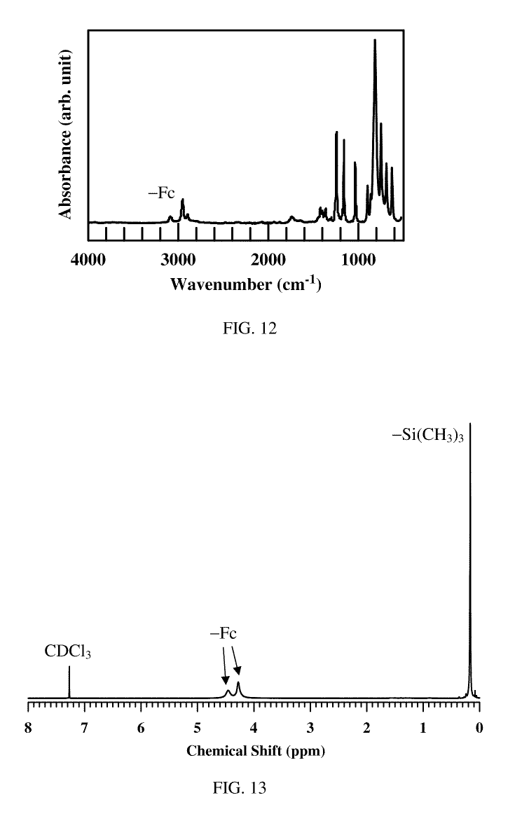

A solution of 62.5 mL 1.6 M butyllithium in hexane was added to ferrocene (7.6 g, 40 mmol) in 100 mL anhydrous hexane at 0° C., and then 15.2 mL N,N,N′,N′-tetramethyl-ethylenediamine (TMEDA) (100 mmol) were added dropwise. This mixture was warmed up to room temperature and stirred for 24 h. The resulting mixture was cooled to −78° C., and trimethylsilyl chloride was added slowly and stirred at this temperature for 2 h. Subsequently, the reaction mixture was allowed to warm to room temperature and stirred overnight. After the reaction was complete, the solution was poured into 200 g ice, and extracted with hexane (4×100 mL). Then, the organic layers were combined, dried over MgSO₄, and concentrated under the reduced pressure. The residue was separated by silica gel flash chromatography using hexane as an eluent to give 8.6 g red liquid. Yield: 65%. ¹H NMR (δ, CDCl₃): 0.18 (d, 18H, —Si(CH₃)₃), 4.28 (s, 4H, —Fc), 4.46 (s, 4H, —Fc). FTIR spectrum (cm⁻¹): 3090 (—Fc), 2950, 1420, 1380, 1240, 1160, 1040, 818, 750, 688, 629. The FTIR spectrum of 1,1′-bis(trimethylsilyl)ferrocene is shown in FIG. 12 and the ¹H NMR spectrum of 1,1′-bis(trimethylsilyl)ferrocene in CDCl₃ is shown in FIG. 13.

### (ii) Synthesis of 1,1′-bis(diphenylphosphino)-3,3′-bis(trimethylsilyl)ferrocene

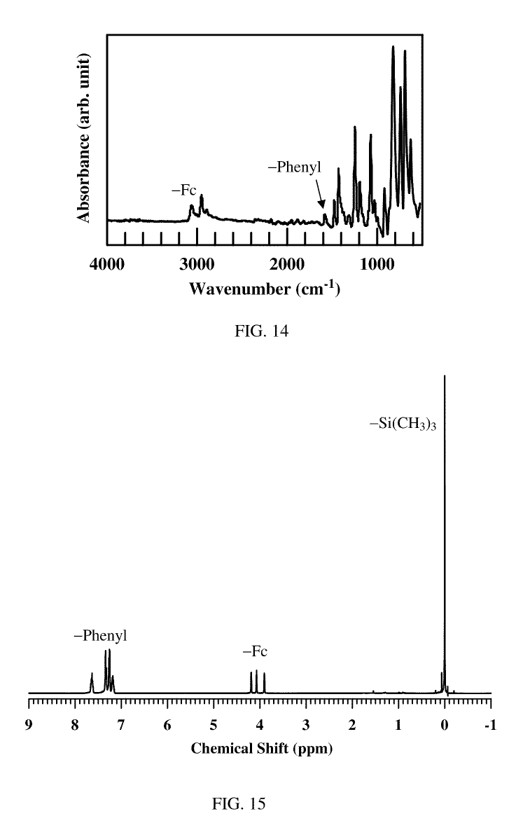

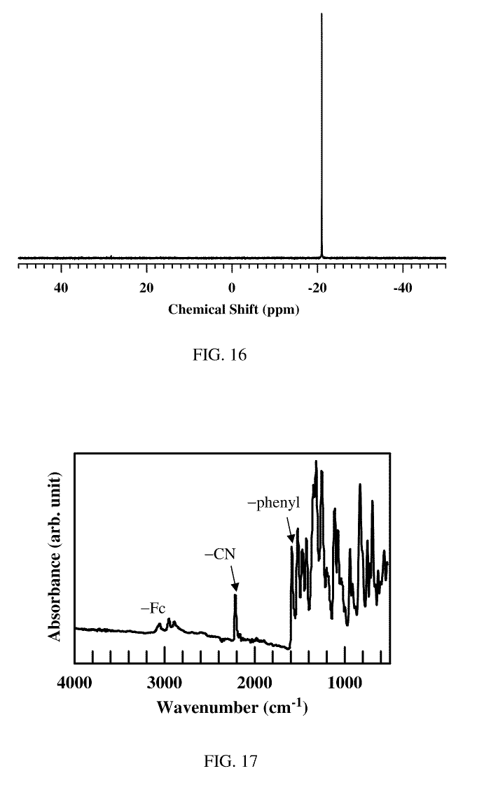

18.8 mL 1.6 M butyllithium in hexane (30 mmol) was added to 1,1′-bis(trimethylsilyl)ferrocene (3.3 g, 10 mmol) in 100 mL anhydrous ether at 0° C., and then 4.6 mL TMEDA (30 mmol) were added dropwise. This mixture was warmed up to room temperature and stirred for 24 h. The resulting mixture was then cooled to −78° C., and 4.6 mL chlorodiphenylphosphine (25 mmol) was added dropwise and maintained for a further 2 h. After that, the reaction mixture was allowed to warm up to room temperature and stirred for 24 h. After cooling to 0° C., it was carefully quenched with 100 mL icy water and the organic layer was separated, followed by washing with 100 mL distilled water twice. The organic layer was dried over Na₂SO₄, and concentrated under the reduced pressure. The residue was separated by silica gel column chromatography using hexane/chloroform (2:1, v/v) as an eluent, and then recrystallized from hexane twice to obtain 2.8 yellow crystals. Yield: 40%. ¹H NMR (δ, CDCl₃): 0.01 (d, 18H, —Si(CH₃)₃), 3.91 (d, 2H, —Fc), 4.08 (s, 2H, —Fc), 4.20 (d, 2H, —Fc), 7.25 (t, 8H, -phenyl), 7.33 (t, 8H, -phenyl), 7.62 (d, 4H, -phenyl). ³¹P NMR (δ, CDCl₃, H₃PO₄ as an external reference): 20.4. FTIR spectrum (cm⁻¹): 3070 (—Fc), 2950, 1590 (-phenyl). The FTIR spectrum of 1,1′-bis(diphenylphosphino)-3,3′-bis(trimethylsilyl)ferrocene is shown in FIG. 14, ¹H NMR spectrum of 1,1′-bis(diphenylphosphino)-3,3′-bis(trimethylsilyl)ferrocene in CDCl₃ is shown in FIG. 15, and the (phosphine-31 nuclear magnetic resonance) (³¹P NMR) spectrum of 1,1′-bis(diphenylphosphino)-3,3′-bis(trimethylsilyl)ferrocene in CDCl₃ using phosphorus acid as an external reference is shown in FIG. 16.

3. Polymerization of TCNAQ-Based Magnetic Polymers

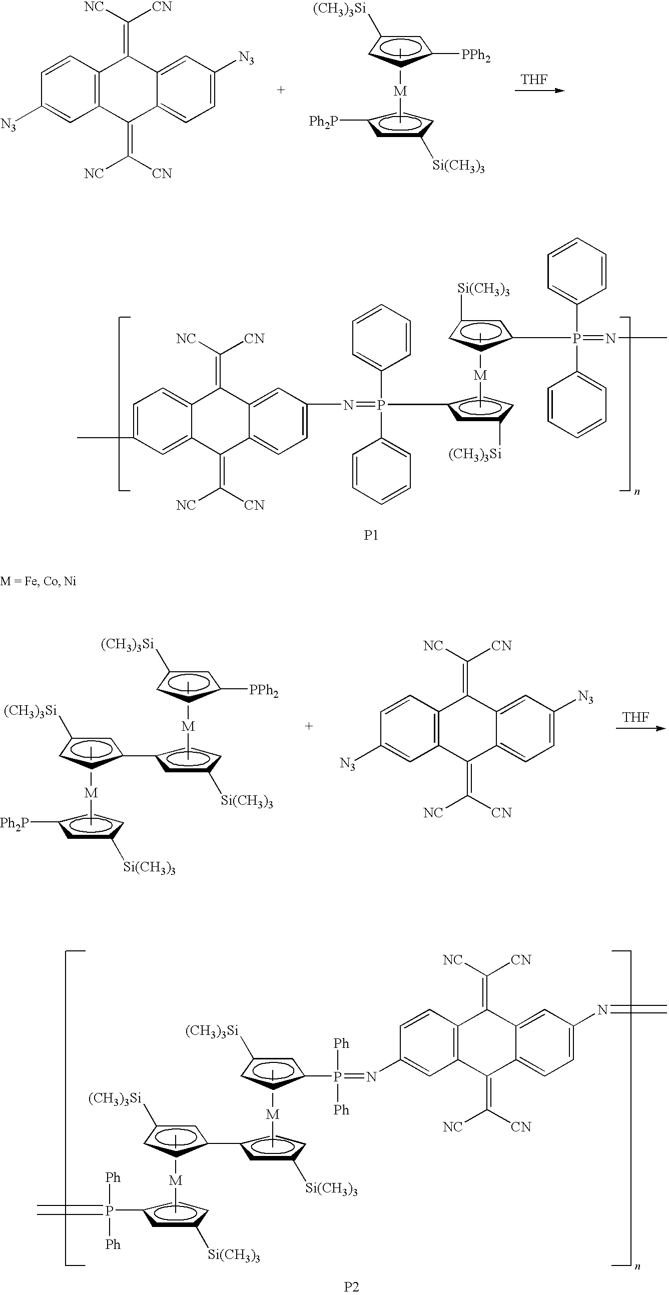

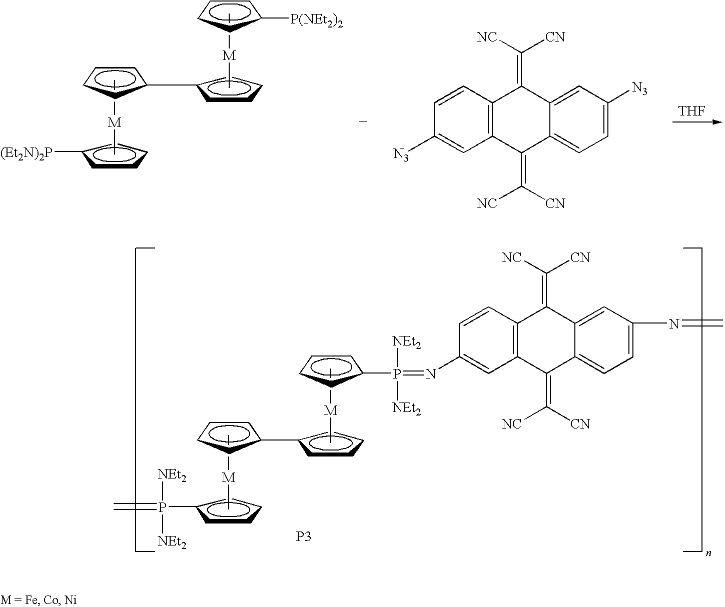

### Example 3

### Polymerization of Molecule-Based Magnetic Polymer P1

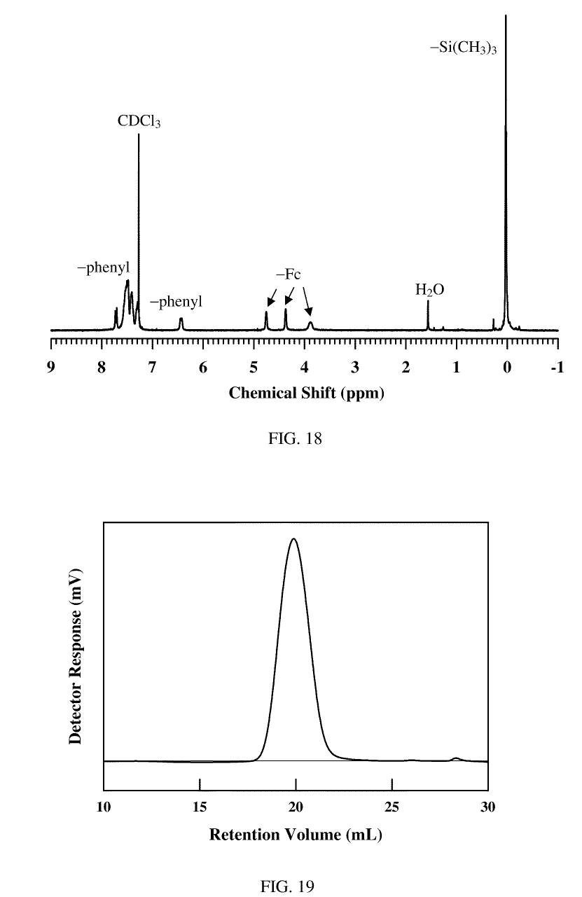

In a 250 mL three-neck round-bottom flask was placed equimolar amounts of monomers, 2,6-diazido-11,11,12,12-tetracyanoanthraquinodimethane (3.9 g, 10 mmol) and 1,1′-bis(diphenylphosphino)-3,3′-bis(trimethylsilyl)ferrocene (7.0 g, 10 mmol), and then 100 mL anhydrous tetrahydrofuran was added at 0° C. The reaction mixture was thoroughly deoxygenated, filled with high-purity argon gas, and then slowly warmed up to room temperature and reacted for 72 h, followed by slightly increasing the temperature to 35° C. for another 11 days. Then, the solution was precipitated in hexanes, filtered, and dried in vacuo at 60° C. to give 9.7 g brown product. Yield: 95%. In order to remove the low molecular weight fraction, gradient precipitation fractionation was employed by dissolving the polymer in THF followed by slowly adding hexane and then collecting the precipitating samples in portions. Finally, the high molecular weight fractions were combined to afford 6.0 g product with narrow molecular weight distribution. ¹H NMR (δ, CDCl₃): 0.01 (d, 18H, —Si(CH₃)₃), 3.89 (s, 2H, —Fc), 4.38 (d, 2H, —Fc), 4.76 (d, 2H, —Fc), 6.43 (s, 2H, -phenyl), 6.30 (d, 2H, -phenyl), 7.50 (m, 20H, -phenyl), 7.74 (d, 2H, -phenyl). FTIR spectrum (cm⁻¹): 3060 (—Fc), 2950, 2890, 2220 (—CN), 1590 (-phenyl). The FTIR spectra of a molecule-based polymer P1 is shown in FIG. 17 and the ¹H NMR spectra of a molecule-based polymer P1 in CDCl₃ is shown in FIG. 18. The GPC measurement that P1 has an Mₙ of 38,720, an M_{w} of 53,670, and polydispersity (M_{w}/Mₙ) of 1.38 is shown in FIG. 19.

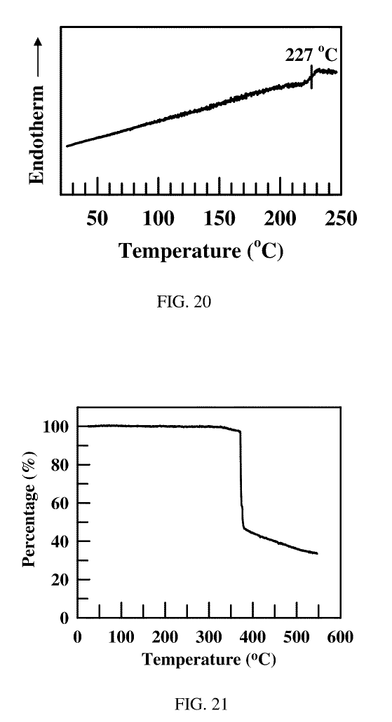

Due to its rigid conjugated structure and the strong electron donor-acceptor interactions (both intermolecular and intramolecular), P1 has a glass transition temperature (T_{g}) at a very high temperature of 227° C. as shown in FIG. 20. The thermal degradation temperature was determined to be above 350° C. as observed from thermogravimetric analysis (TGA) data as shown in FIG. 21. The TGA data given in FIG. 21 indicates that thermal degradation would occur at temperatures above 350° C. Therefore, it can be concluded that it is safe to run magnetic measurements at temperatures below 350° C.

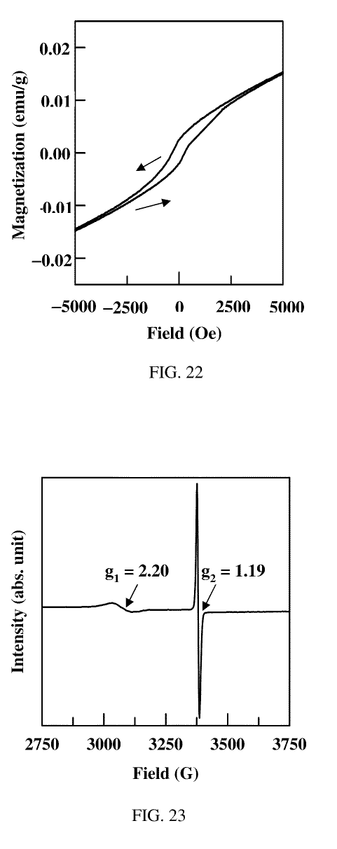

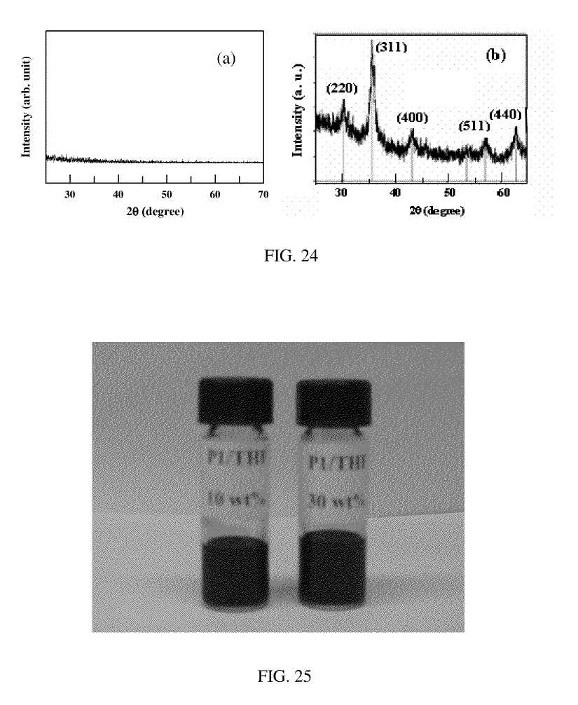

The molecule-based polymer P1 exhibits a ferromagnetic behavior as determined from magnetometry experiment shown in FIG. 22, and also from ESR experiment as shown in FIG. 23. Further it has been found that the molecule-based polymer P1 does not contain any trace of foreign material (e.g., iron oxide) as determined from wide-angle X-ray diffraction (XRD) experiment shown in FIG. 24a. For comparison, XRD patterns of iron oxide are shown in FIG. 24b exhibiting several X-ray intensity peaks characteristic of typical iron oxide.

It has been found that the molecule-based polymer P1 is soluble in common solvents such as tetrahydrofuran, N,N-dimethylformamide, chloroform, and dichloromethane. Photographs of the solutions of molecule-based polymer P1 are shown in FIG. 25, demonstrating that indeed an intrinsically homogeneous magnetic fluid (i.e., liquid magnet) has been prepared from the molecule-based magnetic polymer P1.

Synthesis of TCNQ-Based Magnetic Polymers

The Knoevenagel reaction is a modified version of the Aldol reaction, where aldehydes perform condensation with compounds with the structure Z-CH₂-Z′, here Z and/or Z′ are electron withdrawing groups, such as CHO, COR, COOH, COOR, CN, NO₂, SOR, and SO₂R. Knoevenagel reaction has become a suitable approach to synthesize high molecular weight conjugated polymers. Since 7,7,8,8-Tetracyanoquinodimethane (TCNQ) is a very strong electron withdrawing group, modification of TCNQ with —CH₂CN would make this monomer fairly ready for reacting with a electron donating monomer with aldehyde groups. Therefore, weak base like piperidine can be employed as a catalyst, which may not influence the stability of tetracyano group. Also, because the reactivity of polymerization is high, low temperature polymerization may become possible.

1. Synthesis of TCNQ-Based Electron Accepting Monomers

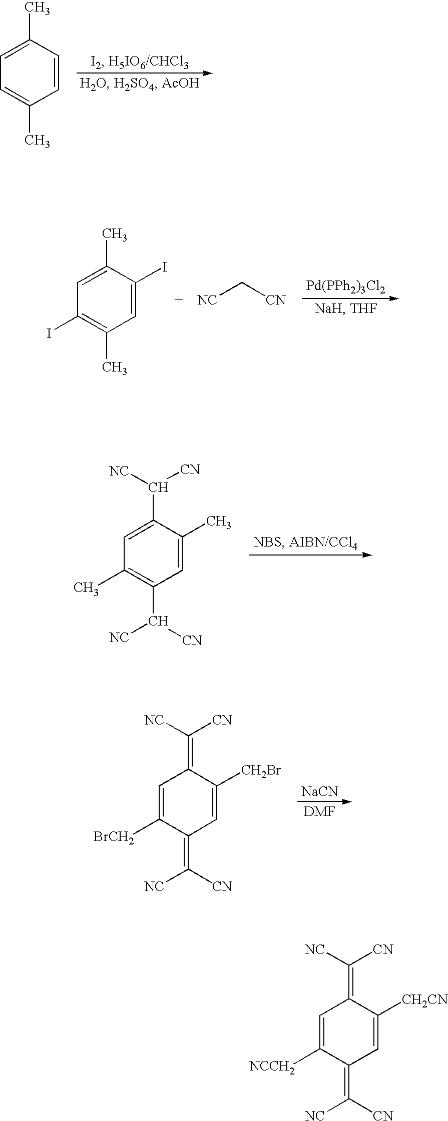

2. Synthesis of Electron Donating Metallocene or Bimetallocene Monomers

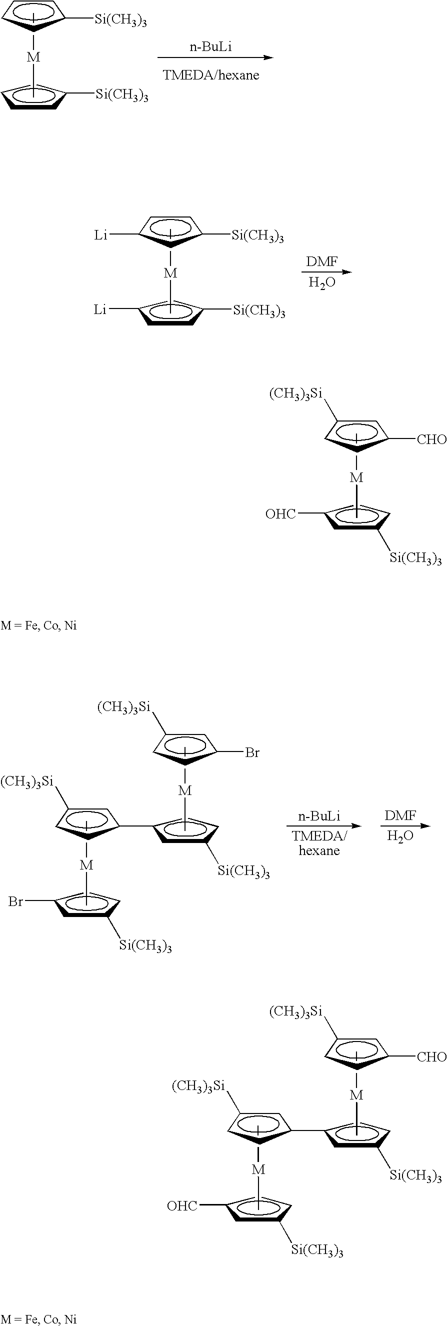

The bimetallocene monomers with aldehyde groups would stabilize the molecule, because the distance between two aldehyde functional groups has been largely increased.

(3) Polymerization of TCNQ-Based Magnetic Polymers

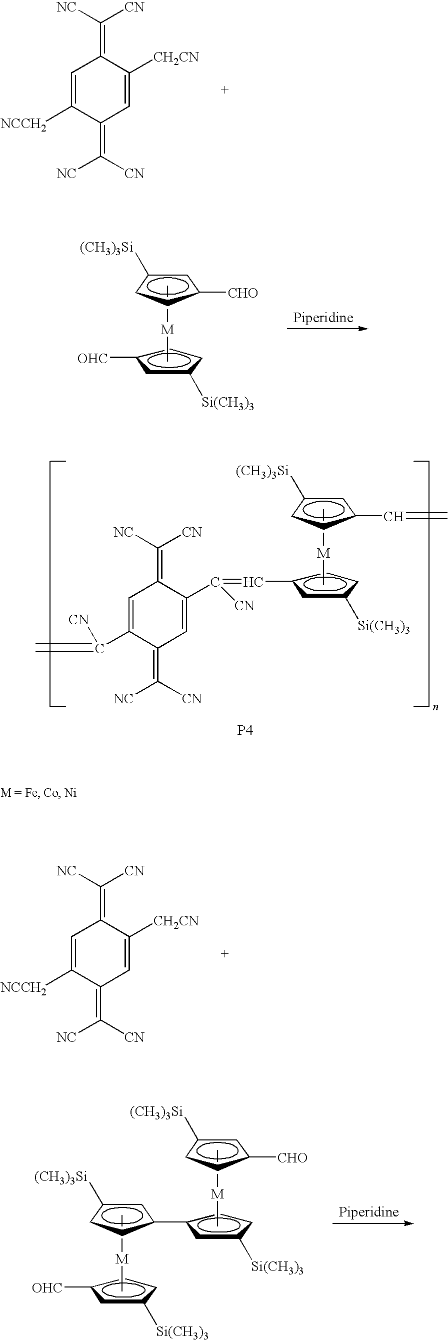

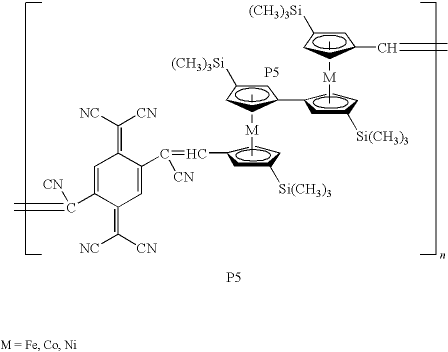

Synthesis of TCNE-Based Magnetic Polymers

Tetracyanoethylene (TCNE) as a strong electron donating molecule undergoes numerous reactions and exists in structural motifs of a variety of organic or inorganic compounds. Of particular interests, TCNE was reported to react with electron-rich acetylenes to afford TCNE derivatives, which were considered to be formed by a ring-opening reaction of initially produced [2+2] cycloadducts. Such reaction mechanism paves a new way to synthesize TCNE-based electron donating monomers having phosphine groups, which would in turn react with metallocene monomers to give molecule-based magnetic polymers.

Synthesis of TCNE-Based Electron Donating Monomers

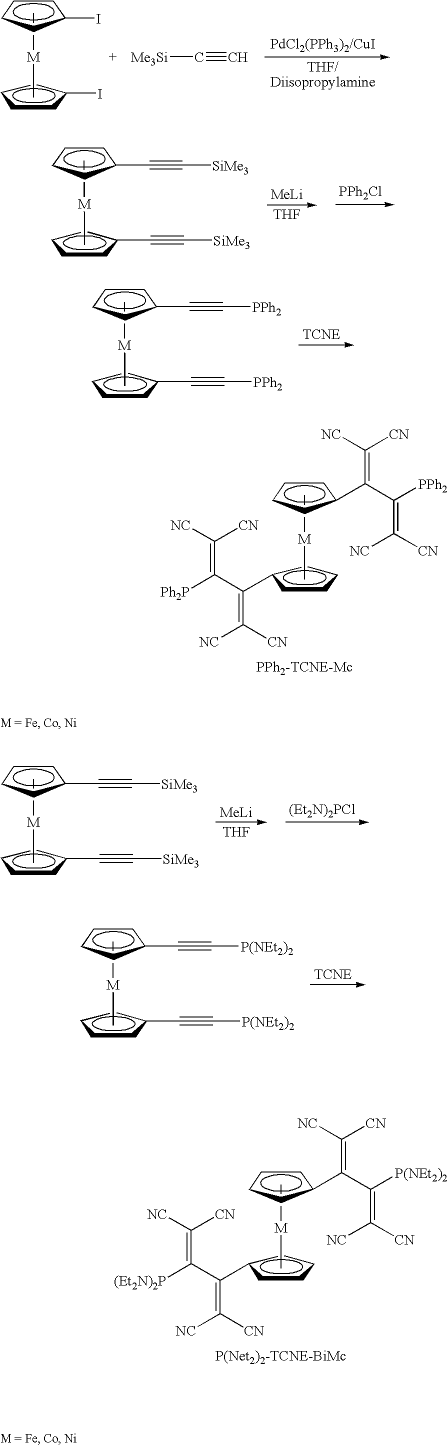

Both PPh₂-TCNE-Mc and P(NEt₂)₂-TCNE-Mc possess a metallocene center, which directly connects with two TCNE units and facilitates the strong intramolecular interactions between electron donating and electron accepting constituents. The diethylamino groups in P(NEt₂)₂-TCNE-Mc may make its reaction with TCNE much easier. The flexible side chains would reduce the steric hindrance. Due to its easy formation of mixed-valence Fe(II)-Fe(III) species and charge transfer complex, bimetallocenes were also synthesized according to the following reaction schemes:

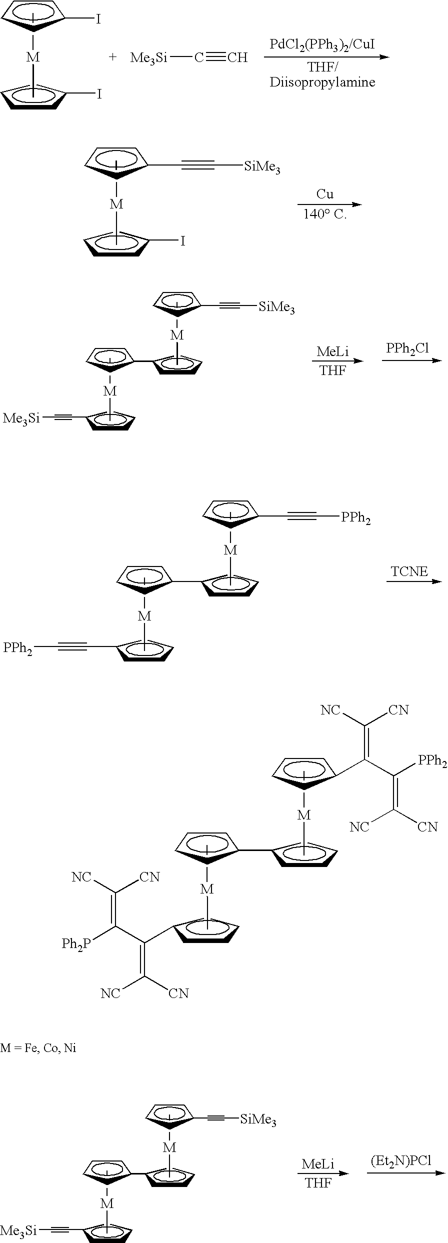

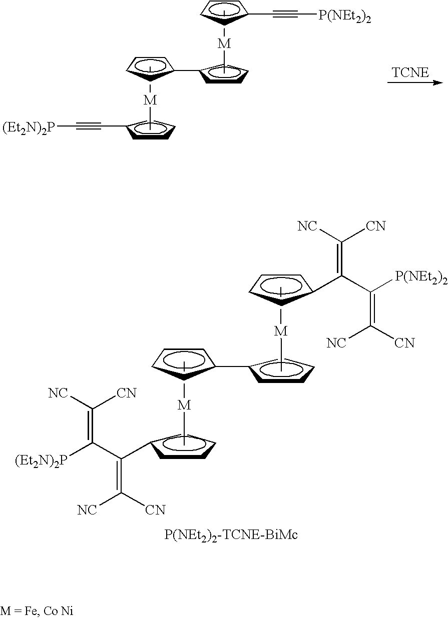

2. Synthesis of Electron Donating Bimetallocene Monomers

1,1′-diazidoferrocene is unstable above 50° C., and rather sensitive to light under ambient conditions. Therefore, a more stable diazido-monomer based on bimetallocene was synthesized, because the number of carbon is largely greater than that of nitrogen and the distance between two azido-groups has been dramatically enlarged.

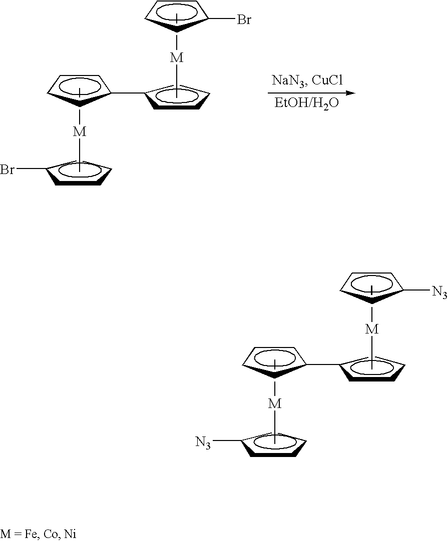

3. Polymerization of TCNE-Based Magnetic Polymers

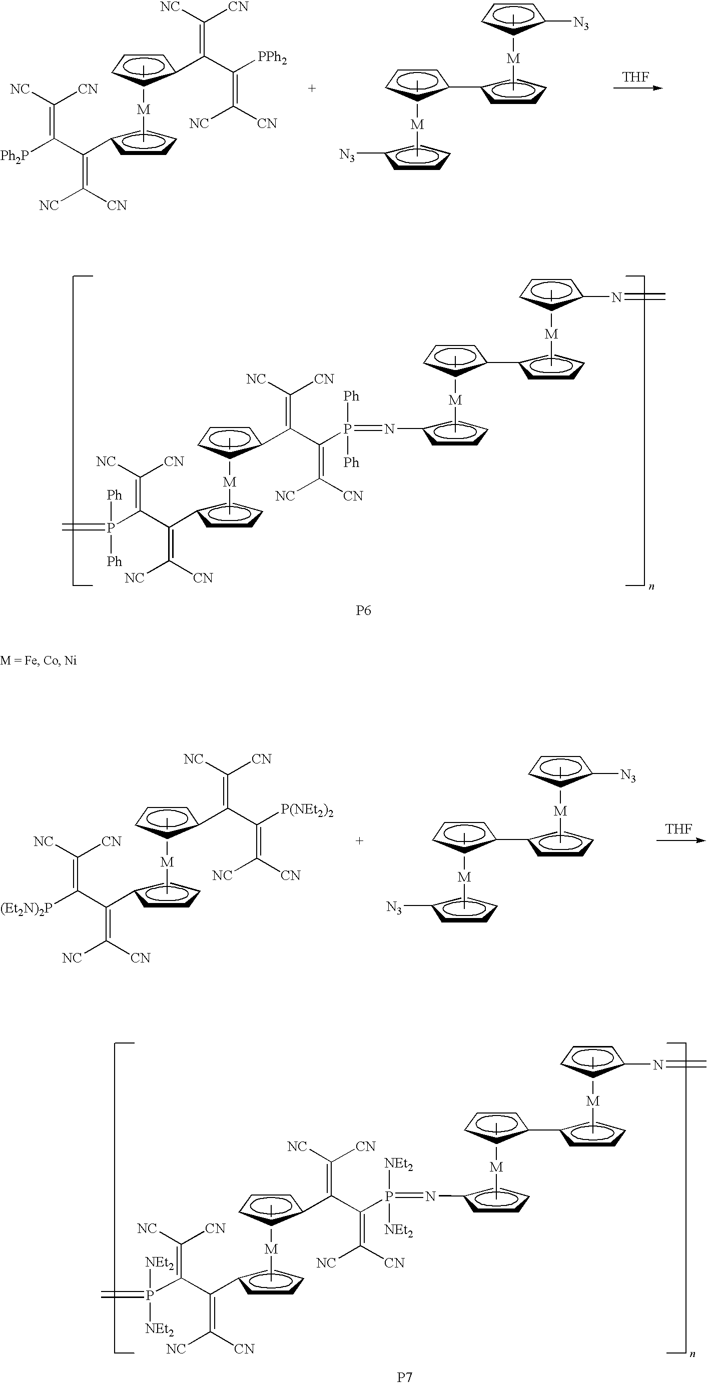

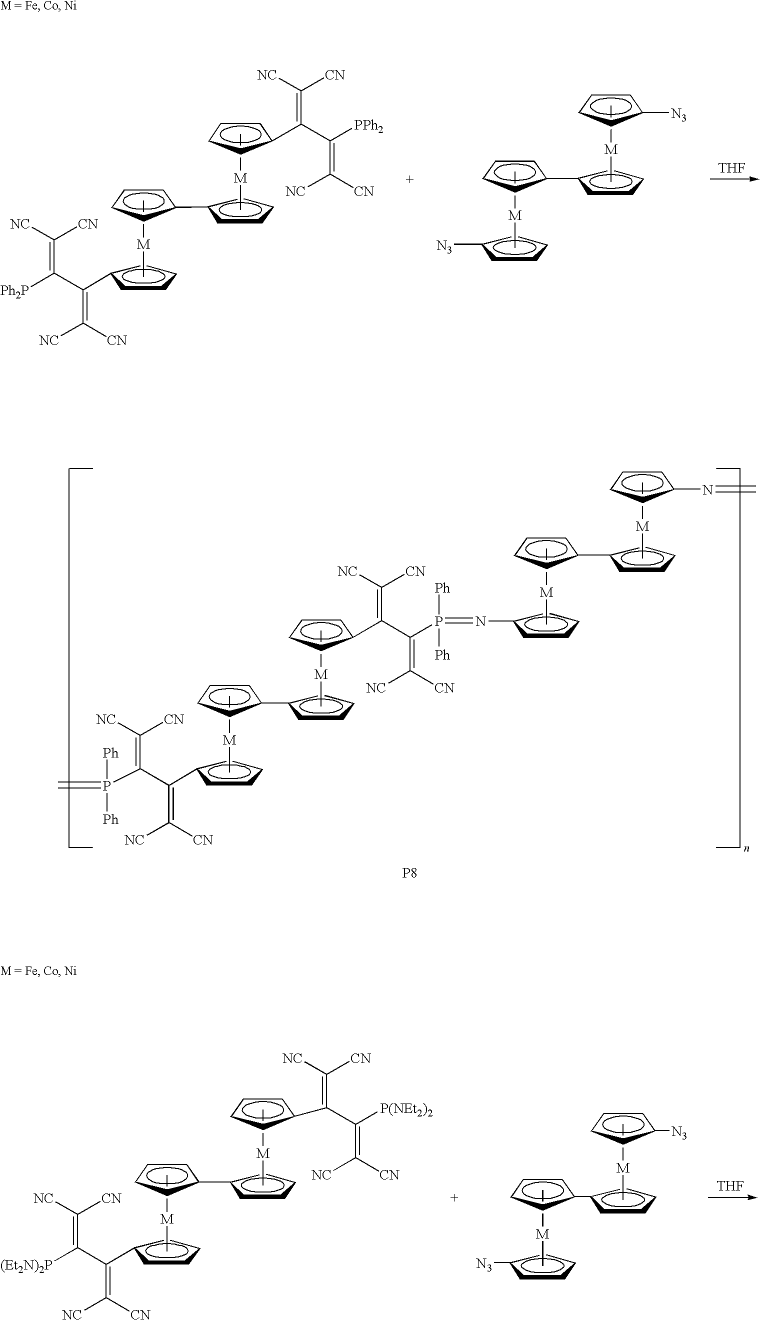

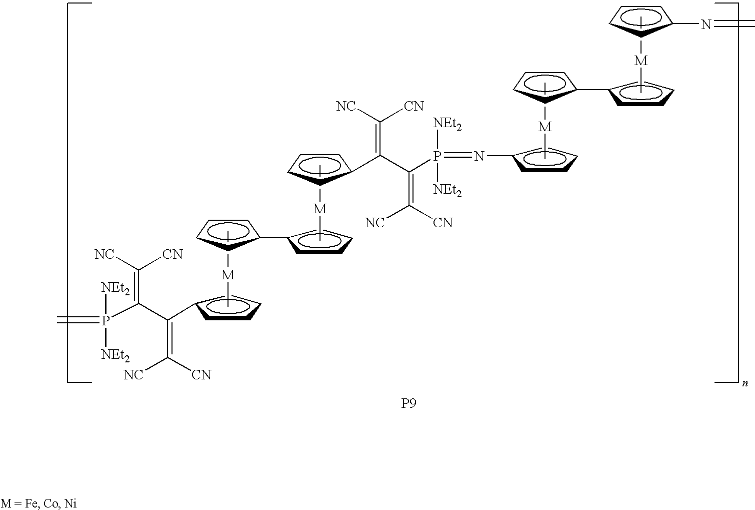

4. Synthesis of TCNE-Based Magnetic Polymers via Post-Polymerization Reaction

Considering the high reactivity of TCNE with ethynyl group in the presence of strong electron donating groups such as amonio group, we synthesized three additional TCNE-based magnetic polymers by incorporating TCNE units either in the main chain or in the side chain. Specifically, we first synthesized metallocene-containing conjugated polymers having ethynyl groups and amino groups through carbon-carbon coupling reactions using different metal-ion containing catalyst systems. After that, these conjugated polymers performed further reaction with TCNE to afford the respective magnetic polymers.

(a) Main-Chain TCNE-Based Bimetallocene Magnetic Polymers

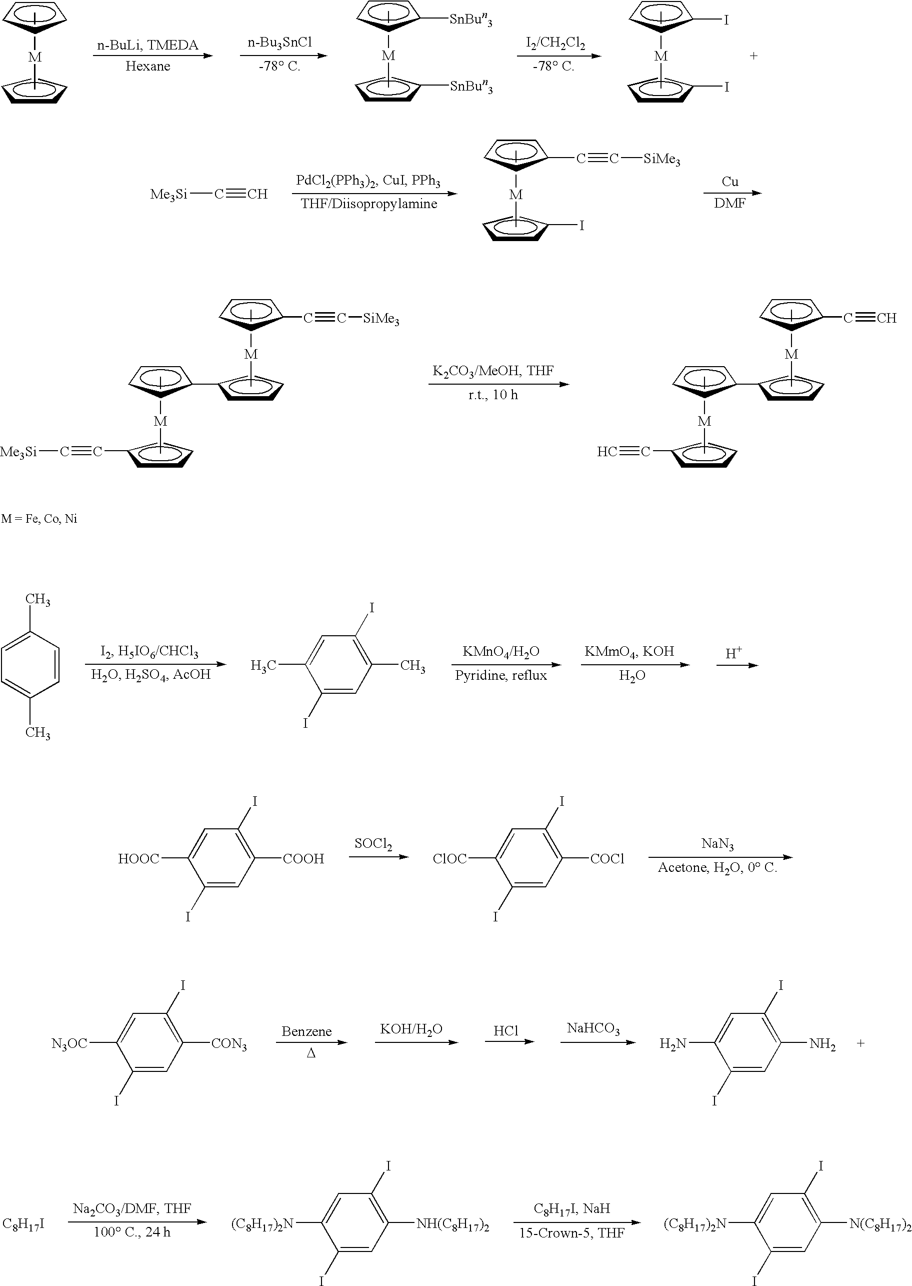

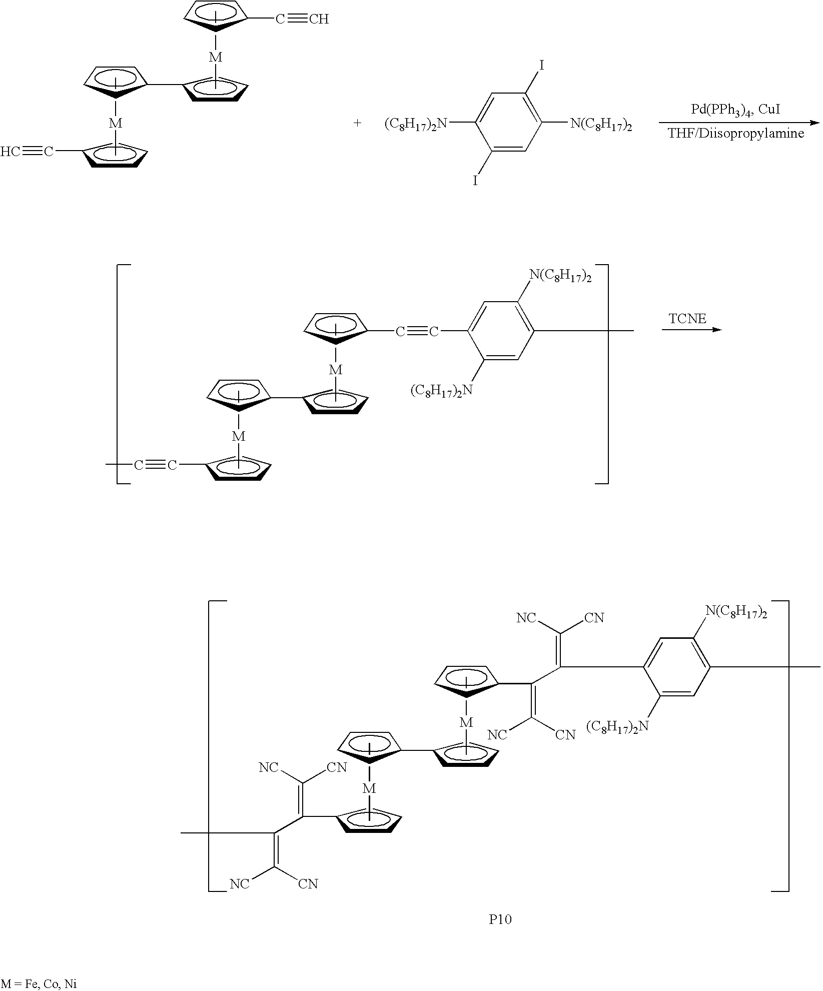

The conjugated bimetallocene polymer is obtained by Sonogashira cross-coupling reaction. The amino groups on the benzene ring will ensure the high reactivity of ethynyl group with TCNE, while the bimetallocene will facilitate both ethynyl groups in each repeat unit to react with TCNE.

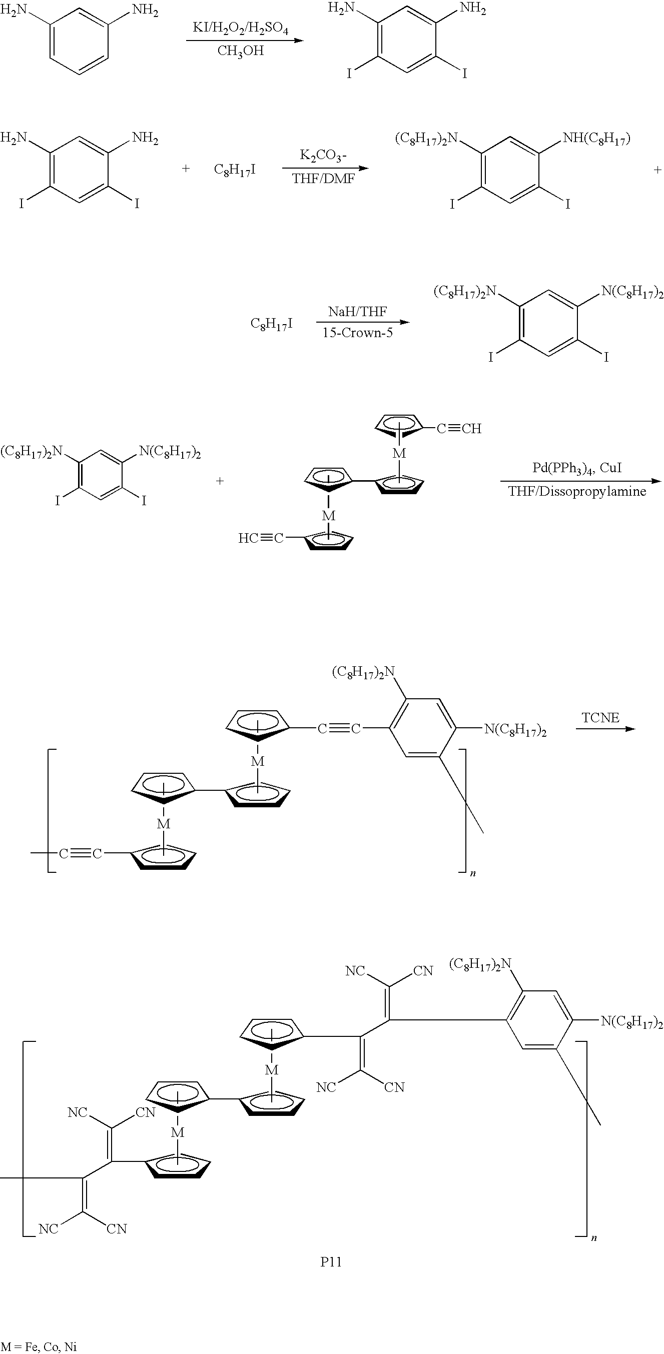

The unique feature of the polymer P11 is that the amino group lies in the para-position of the triple bond, which would give rise to a large increase in the reactivity of the triple bond with TCNE. Since P11 has amino groups in para- and ortho-positions of the triple bond in this polymer, it is quite possible that both triple bonds in each repeat unit would react with TCNE. Also, the meta-benzene unit in P11 would further improve the solubility of the polymer.

(b) Side-Chain TCNE-Based Magnetic Polymers

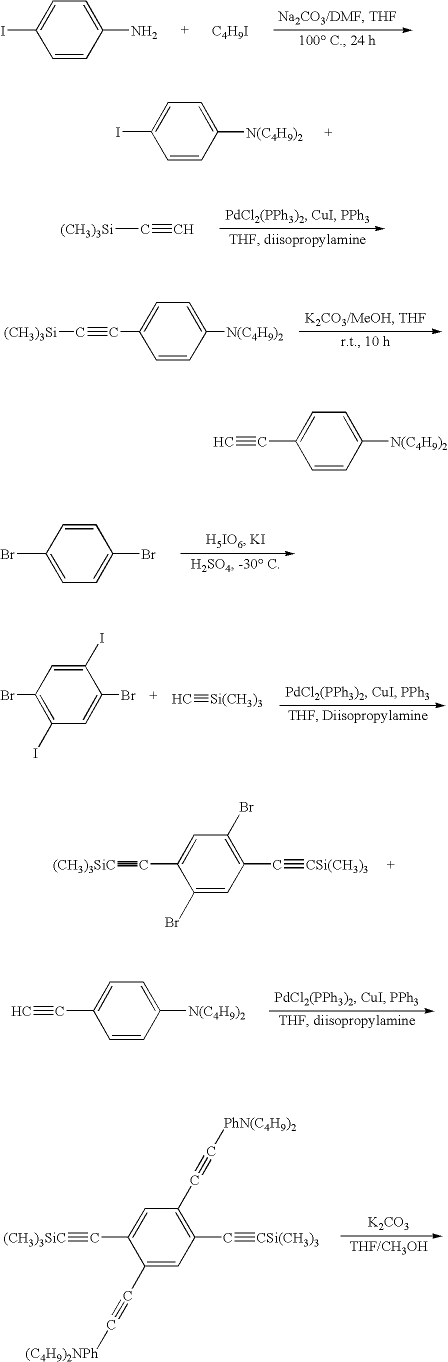

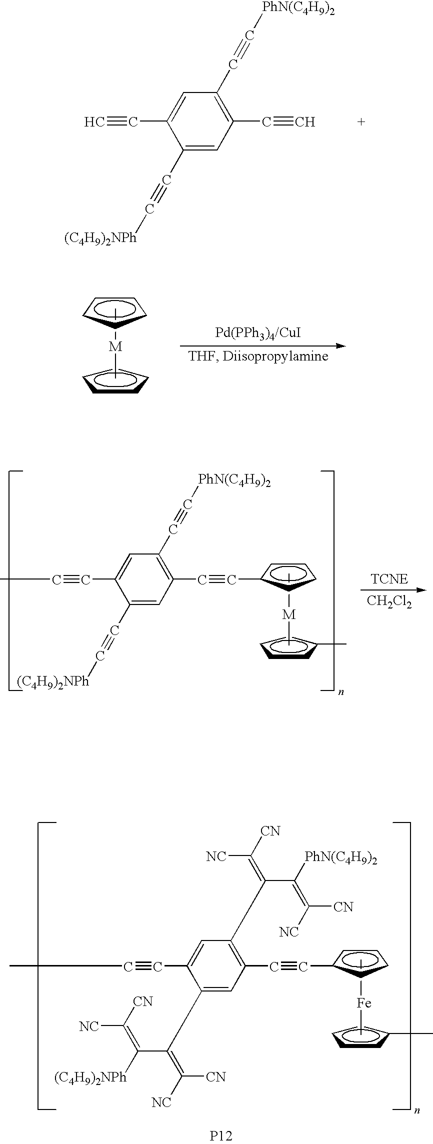

The metallocene conjugated polymer is also achieved by Sonogashira cross-coupling reaction. In the chemical structure of this conjugated polymer, the two ethynyl groups in the side chain of each repeat unit are much easier to react with TCNE and form a very strong electron donating center, and consequently the two ethynyl groups in the main chain would become rather difficult to react with TCNE.

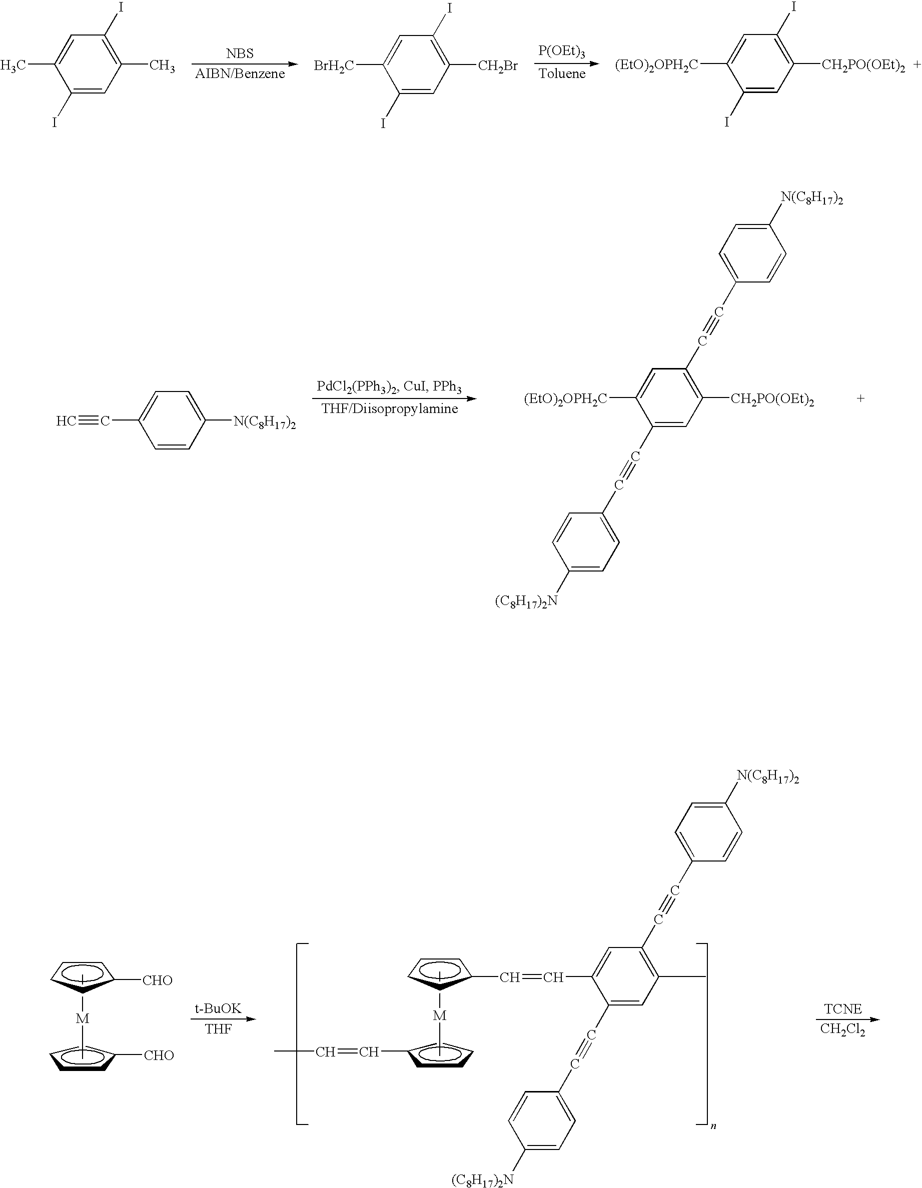

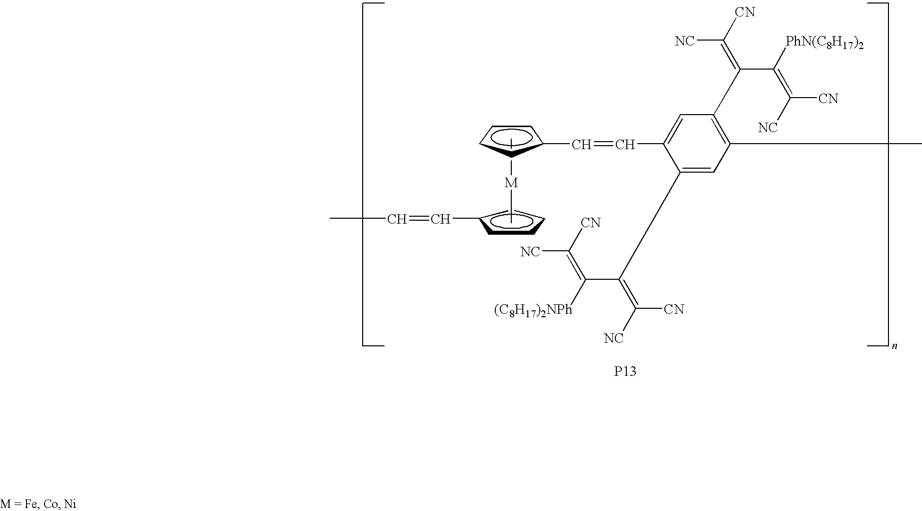

Since the chemical structure of P12 is very rigid, it has only limited solubility in solvents and relatively low molecular weight. Therefore, another magnetic polymer P13 was first polymerized by Horner-Wadsworth-Emmons olefination reaction of dialdehydes and bisphosphonates and then reacted with TCNE. The solubility of P13 would be enhanced considerably due to the use of the ethylene group, which has less rigidity than the ethynyl group, and the longer flexible side chains.

(c) Side-Chain TCNE-Based Magnetic Polymers with TCNE in the Metallocene Unit

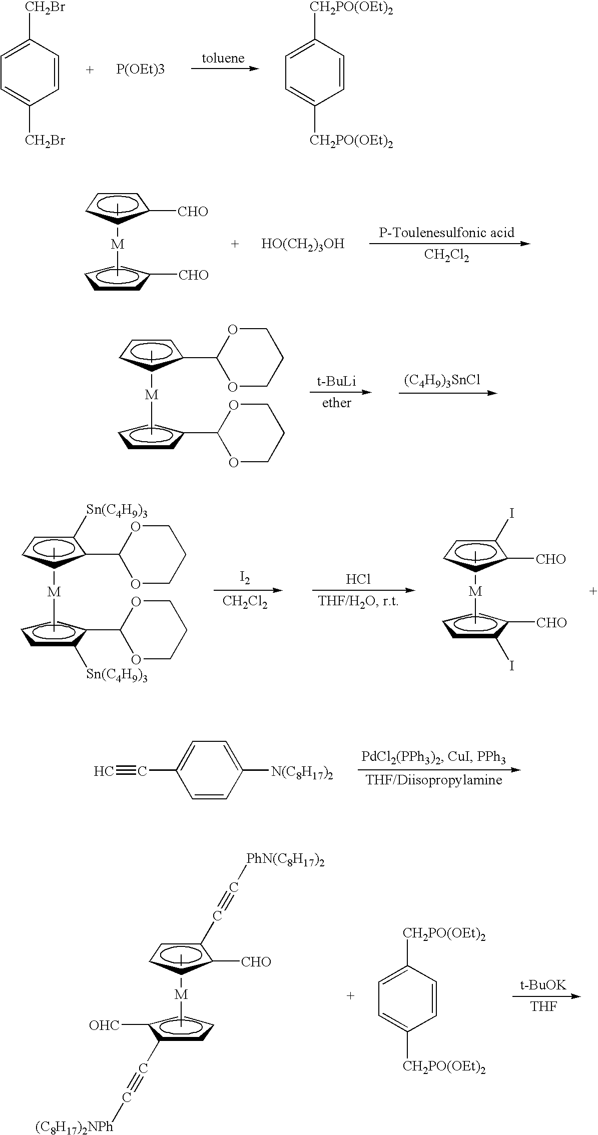

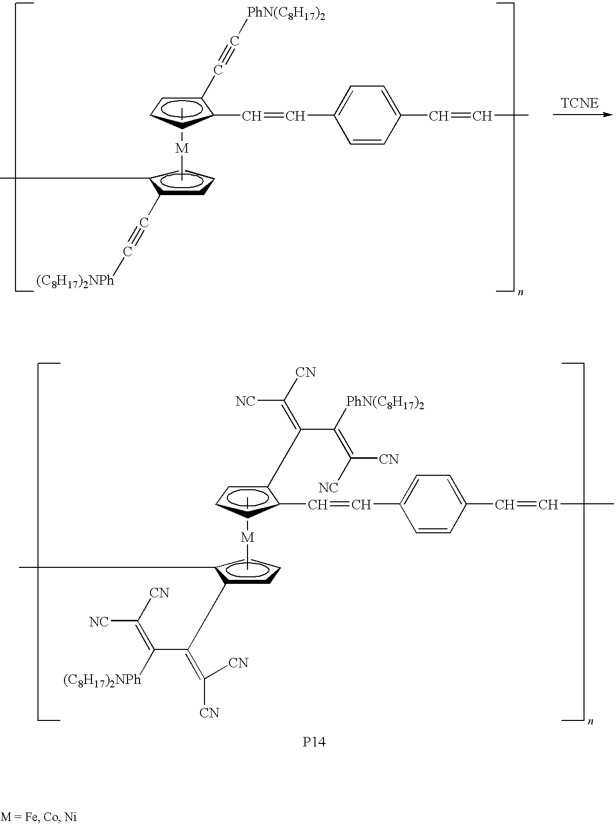

In the chemical structure of metallocene conjugated polymer P14, which is also polymerized by Horner-Wadsworth-Emmons olefination reaction, the two ethynyl groups in the side chain are directly linked to metallocene unit, and thus form the charge transfer complexes in the side chain.

The synthesis procedures for a series of high-T_{c} molecule-based magnetic polymers are provided along with the presentation of representative properties of the synthesized magnetic polymers via electron spin resonance (ESR) spectrometry and X-ray diffraction (XRD). FIG. 23 gives an ESR spectrum of the molecule-based magnetic polymer P1. The ESR spectrum indicates the presence of spin-spin interactions between the constituent monomers that constitute the P1 magnetic polymer. As seen in FIG. 24a, XRD pattern (intensity versus two-theta (2θ) angle) for the molecule-based magnetic polymer P1 is given. The XRD pattern for P1 is clearly distinct from the XRD pattern for iron oxide as shown in FIG. 24b. In particular, the XRD pattern for P1 has no reflection peaks for the values of 2θ ranging from 30 to 70 degrees, whereas iron oxide has several reflection peaks in the same range of 2θ values. Thus we can conclude that P1 is substantially devoid of iron oxide.

As can be seen in FIGS. 23-25, the molecule-based magnetic polymer P1, for example, have the following features: (1) it exhibits the presence of spin-spin interactions between the constituent components within the polymer (FIG. 23), (2) it is free of any magnetic metallic particles and thus is homogeneous (FIG. 24a), and (3) it is soluble in common solvents, as shown in FIG. 25, offering good processability.

In one embodiment of the invention, the magnetic fluids (liquid magnets), which can be prepared from the molecule-based magnetic polymers P1-P14 are intrinsically homogeneous. Hence, these liquid magnets can replace conventional ferrofluids or MR fluids, which are suspensions of magnetic nanoparticles, currently found in the marketplace.

Based upon the foregoing disclosure, and the examples thereof, it should now be apparent that the method of preparing molecule-based magnetic polymers and use of these polymers in preparing magnetic fluids described herein will carry out the objects set forth hereinabove. It is, therefore, to be understood that any variations evident fall within the scope of the claimed invention and thus, the selection of specific component elements can be determined without departing from the spirit of the invention herein disclosed and described.

What is claimed is:

1. A magnetic polymer comprising:
repeating units of an organometallic monomer covalently bonded to a monomer having a plurality of unpaired electrons.

2. The magnetic polymer of claim 1, wherein the organometallic monomer is covalently bonded to a monomer through Staudinger reaction or Knoevenagel reaction.

3. The magnetic polymer of claim 1, wherein the organometallic monomer is a metallocene.

4. The magnetic polymer of claim 3, wherein the metallocene is a ferrocene-, cobaltocene-, nickelocene-modified compound.

5. The magnetic polymer of claim 3, wherein the metallocene is modified with at least one phosphine, azide, or aldehyde groups having flexible side chains or bulky pendent groups.

6. The magnetic polymer of claim 1, wherein the monomer having a plurality of unpaired electrons comprises at least an 11,11,12,12-tetracyano-9,10-anthraquinodimethane (TCNAQ), 7,7,8,8-tetracyanoquinodi-amine (TCNQ) and tetracyanoethyelene (TCNE) unit and azide, phosphine, or methylcyano groups.

7. The magnetic polymer of claim 1, wherein the polymer is produced through firstly synthesizing metallocene conjugated polymers with ethynyl groups and amino groups followed by reacting the ethynyl groups with tetracyanoethyelene (TCNE).

8. The magnetic polymer of claim 7, wherein the step of synthesizing metallocene conjugated polymers with ethynyl groups and amino groups is performed using Sonogashira cross-coupling reaction or Wittig reaction.

9. The magnetic polymer of claim 7, wherein the organometallic conjugated polymer is a metallocene or bimetallocene.

10. The magnetic polymer of claim 9, wherein the metallocene is a ferrocene-, cobaltocene- or nickelocene-modified compound, and bimetallocene is a biferrocene-, bicobaltocene-, or binickelocene-modified compound.

11. A method of preparing a magnetic polymer, the method comprising the steps of:
preparing an organometallic monomer; preparing at least one monomer having a plurality of unpaired electrons; and
polymerizing the organometallic monomer and at least one monomer having a plurality of unpaired electrons to form a magnetic polymer.

12. The method of claim 11, wherein the step of polymerizing is performed through Staudinger reaction or Knoevenagel reaction.

13. The method of claim 11, wherein the organometallic monomer is a bimetallocene.

14. The method of claim 13, wherein the metallocene is a biferrocene-, bicobaltocene-, or binickelocene-modified compound.

15. The method of claim 14, wherein the biferrocene-, bicobaltocene-, or binickelocene-modified compound is modified with at least one phosphine, azide, or aldehyde groups having flexible side chains or bulky pendent groups.

16. The method of claim 11, wherein the monomer having a plurality of unpaired electrons comprises at least an 11,11,12,12-tetracyano-9,10-anthraquinodimethane (TCNAQ), 7,7,8,8-tetracyanoquinodi-amine (TCNQ) and tetracyanoethyelene (TCNE) unit and azide, phosphine, or methylcyano groups.

17. An intrinsically homogeneous magnetic fluid comprising a magnetic polymer comprising repeating units of an organometallic monomer covalently bonded to a monomer having a plurality of unpaired electrons.

18. The intrinsically homogeneous magnetic fluid of claim 17 comprises of the organometallic monomer is a metallocene.

19. The intrinsically homogeneous magnetic fluid of claim 18, wherein the metallocene comprises a ferrocene cobaltocene-, nickelocene-modified compound.

20. The intrinsically homogeneous magnetic fluid of claim 18, wherein the metallocene is modified with at least one phosphine, azide, or aldehyde groups having flexible side chains or bulky pendent groups.

21. The intrinsically homogeneous magnetic fluid of claim 17, wherein the monomer having a plurality of unpaired electrons comprises at least an 11,11,12,12-tetracyano-9,10-anthraquinodimethane (TCNAQ), 7,7,8,8-tetracyanoquinodi-amine (TCNQ) and tetracyanoethyelene (TCNE) unit and azide, phosphine, or methylcyano groups.

22. The intrinsically homogeneous magnetic fluid of claim 17, wherein the organometallic monomer covalently bonded to a monomer having a plurality of unpaired electrons is disposed in a carrier solvent.

23. The intrinsically homogeneous magnetic fluid of claim 22, wherein the carrier solvent is an organic solvent.

24. The intrinsically homogeneous magnetic fluid of claim 17, further comprising:
a carrier solvent; and wherein
the magnetic polymer is soluble in the carrier solvent, wherein the magnetic polymer comprises repeating units of an electron-donor bimetallocene-containing monomer covalently bonded to a monomer having a plurality of unpaired electrons.

25. The intrinsically homogeneous magnetic fluid of claim 24, wherein the metallocene is a biferrocene-, bicobaltocene-, or binickelocene-modified compound.

26. The intrinsically homogeneous magnetic fluid of claim 25, wherein the biferrocene-, bicobaltocene-, or binickelocene-modified compound is modified with at least one phosphine, azide, or aldehyde groups having flexible side chains or bulky pendent groups.

27. The intrinsically homogeneous magnetic fluid of claim 24, wherein the monomer having a plurality of unpaired electrons comprises at least an 11,11,12,12-tetracyano-9,10-anthraquinodimethane (TCNAQ), 7,7,8,8-tetracyanoquinodiamine (TCNQ) and tetracyanoethyelene (TCNE) unit and azide, phosphine, or methylcyano groups.

28. The intrinsically homogeneous magnetic fluid of claim 24, wherein the carrier solvent is an organic solvent.

29. An intrinsically homogeneous magnetic fluid comprising an organometallic polymer that reacts with tetracyanoethyelene (TCNE) to form a magnetic polymer.

30. The intrinsically homogeneous magnetic fluid of claim 29, wherein the organometallic polymer is a metallocene or bimetallocene conjugated polymer.

31. The intrinsically homogeneous magnetic fluid of claim 30, wherein the metallocene comprises a ferrocene-, cobaltocene-, nickelocene-conjugated polymer, or a biferrocene-, cobaltocene-, or nickelocene-conjugated polymer.

32. The intrinsically homogeneous magnetic fluid of claim 29, wherein the carrier solvent is an organic solvent.
